(19) United States
(12) Patent Application Publication
(10) Pub. No.: US 2025/0390640 A1
(43) Pub. Date: Dec. 25, 2025

(54) THERMODYNAMIC COMPUTING SYSTEM CONFIGURED TO EMULATE DEEP NEURAL DIFFUSION

(71) Applicant: Extropic Corp., Austin, TX (US)

(72) Inventors: Christopher Chamberland, Austin, TX (US); Guillaume Verdon-Akzam, San Fransisco, CA (US)

(73) Assignee: Extropic Corp., Austin, TX (US)

(21) Appl. No.: 18/977,696

(22) Filed: Dec. 11, 2024

Related U.S. Application Data
(60) Provisional application No. 63/662,936, filed on Jun. 21, 2024.

(51) Int. Cl. G06F 30/27; G06F 111/08; G06F 111/10

(52) U.S. Cl. CPC G06F 30/27; G06F 2111/08; G06F 2111/10

(57) ABSTRACT

A thermodynamic computing chip that is configured emulate deep neural diffusion of a deep energy-based model (EBM) and sample input values. In some embodiments, a deep EBM may comprise one or more EBMs that process thermodynamic information via thermodynamic evolution. Relay oscillators or measurements may be utilized to obtain gradients of the deep EBM and thus sample input values.

### BACKGROUND

### Related Application

This application claims benefit of priority to U.S. Provisional Application Ser. No. 63/662,936, entitled “THERMODYNAMIC COMPUTING SYSTEM CONFIGURED TO IMPLEMENT TIME-SCALE SEPARATED FULLY PROGRAMMABLE DEEP NEURAL DIFFUSION,” filed Jun. 21, 2024, and which is incorporated herein by reference in its entirety.

### Description of Related Art

Various algorithms, such as machine learning algorithms, often use statistical probabilities to make decisions or to model systems. Some such learning algorithms may use Bayesian statistics, or may use other statistical models that have a theoretical basis in natural phenomena. In the execution of such algorithms, typically such statistical probabilities are calculated using classical computing devices, wherein the statistical probabilities are then used by other aspects of the algorithm. As an example, statistical probabilities may be used to generate a random number, wherein the random number is then used to evaluate some other aspect of the algorithm.

Generating such statistical probabilities may involve performing complex calculations which may require both time and energy to perform, thus increasing a latency of execution of the algorithm and/or negatively impacting energy efficiency. In some scenarios, calculation of such statistical probabilities using classical computing devices may result in non-trivial increases in execution time of algorithms and/or energy usage to execute such algorithms.

### BRIEF DESCRIPTION OF THE DRAWINGS

FIG. 1 is a high-level diagram illustrating a deep energy-based model (EBM) implemented on one or more thermodynamic chips, wherein a classical computing device determines gradients of the deep EBM and generates sample input values, according to some embodiments.

FIG. 2 is a high-level diagram illustrating sets of relay oscillators configured to be coupled to oscillators of a deep energy-based model (EBM), wherein the coupling enables gradient terms to be obtained to emulate deep neural diffusion of the deep EBM, according to some embodiments.

FIG. 3 is a high-level diagram illustrating oscillators of a deep energy-based model (EBM) configured to be measured, wherein the measurements enable gradient terms to be obtained to emulate deep neural diffusion of the deep EBM, according to some embodiments.

FIG. 4 is a high-level diagram illustrating a deep energy-based model (EBM), which may be used to sample input values, according to some embodiments.

FIG. 5 is a diagram illustrating hardware components that may be used to implement oscillators of energy-based models (EBMs), as well as two different example hardware configurations of a relay oscillator that have a time-dependent mass or a time-dependent frequency, respectively, according to some embodiments.

FIG. 6 is a diagram providing additional details regarding a hardware configuration used to implement a relay oscillator with a time-dependent frequency, according to some embodiments.

FIG. 7 is a diagram providing additional details regarding a hardware configuration used to implement a relay oscillator with a time-dependent mass, according to some embodiments.

FIG. 8 is a high-level diagram illustrating an output oscillator, an input oscillator, and a relay gadget, wherein the relay gadget comprises a group of relay oscillators and is configured to relay thermodynamic information between the output oscillator and the input oscillator and includes bias oscillators, according to some embodiments.

FIG. 9 is a high-level diagram illustrating a spatial analogue relay gadget, wherein respective ones of relay oscillators of a group of relay oscillators are configured to store respective sample values of an output oscillator, according to some embodiments.

FIG. 10 is a high-level diagram illustrating a temporal analogue relay gadget, wherein a group of relay oscillators comprises a single relay oscillator, according to some embodiments.

FIG. 11 is a high-level diagram illustrating a series analogue relay gadget, wherein a group of relay oscillators comprises a plurality of relay oscillators arranged in series, according to some embodiments.

FIG. 12A illustrates example couplings between visible neurons of an energy-based model (EBM), according to some embodiments.

FIG. 12B illustrates example couplings between visible neurons and non-visible neurons (e.g., hidden neurons) of an energy-based model (EBM), according to some embodiments.

FIG. 13 is a high-level diagram illustrating oscillators included in a substrate of the thermodynamic chip and mapping of the oscillators to logical neurons of the thermodynamic chip, according to some embodiments.

FIG. 14 is an additional high-level diagram illustrating oscillators included in a substrate of the thermodynamic chip mapped to logical neurons, weights, and biases of a given neuro-thermodynamic computing system, according to some embodiments.

FIG. 15 is a high-level flowchart illustrating a process of emulating deep neural diffusion using a deep energy-based model implemented on one or more thermodynamic chips to generate sample values, according to some embodiments.

FIG. 16 is a block diagram illustrating an example computer system that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof.

### DETAILED DESCRIPTION

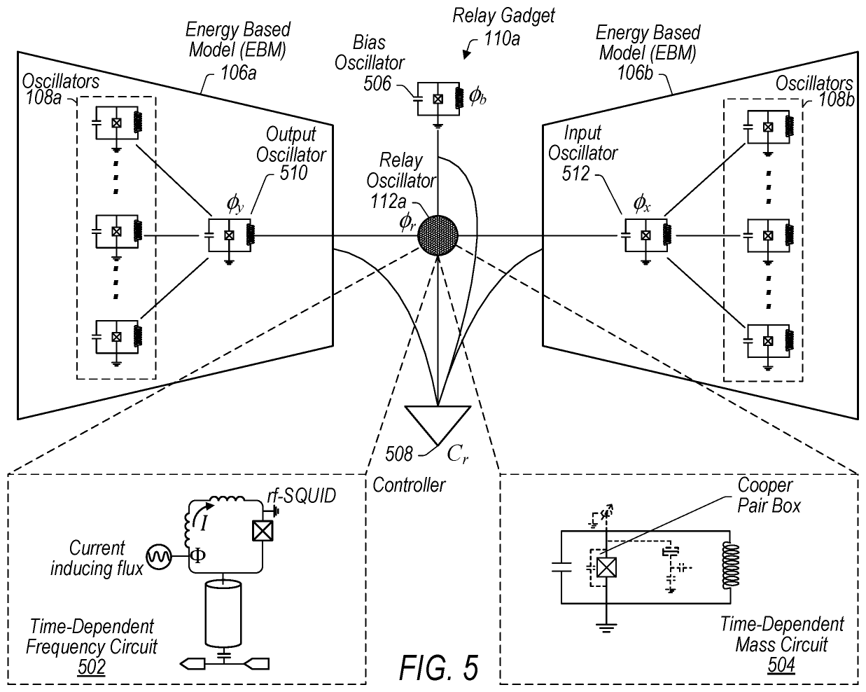

The present disclosure relates to methods, systems, and/or apparatuses for emulating deep neural diffusion using a thermodynamic processor. In some embodiments, one or more energy-based models (EBMs) implemented on one or more thermodynamic chips may be coupled together to implement a deep EBM. The EBMs and the deep EBM may have oscillators configured to obtain, process, or relay thermodynamic information. Components of the deep EBM may be constructed in hardware such as illustrated in FIGS. 5-7 and 13-14. Gradients of a deep EBM may be calculated using methods disclosed herein, wherein sample input values may be generated.

In some embodiments, one or more thermodynamic chips may implement a deep energy-based model (deep EBM), wherein the deep EBM may thermodynamically evolve according to Langevin dynamics. The deep EBM may comprise one or more EBMs that respectively have oscillators. Oscillators of the EBMs may include neuron oscillators representing neuron values of a neural network, synapse oscillators representing synapse values of the neural network, wherein the synapse oscillators when coupled with the neuron oscillators establish an energy potential that is configured to be perturbed. The neural network may be implemented in whole or in part on the one or more thermodynamic chips. The deep EBM may also have one or more input oscillators configured to provide input thermodynamic information to the deep EBM as well as an output oscillator configured to provide output thermodynamic information from the deep EBM. The output thermodynamic information may be encoded in an expectation value of the output oscillator and may represent the output of a function that takes on input values via the input oscillators. In some embodiments, a classical computing device may be configured to receive measurement values of respective oscillators of respective ones of the one or more EBMs or measurement values of a set of relay oscillators configured to be measured. The measurements may be taken subsequent to thermodynamic evolution of the deep EBM. Furthermore, the classical computer may determine a gradient for an evolved state of the deep EBM with respect to the input thermodynamic information provided to the deep EBM based on the received measurement values. Finally, the one or more classical computing devices may generate sample input values for the deep EBM based on the gradients for the evolved state of the deep EBM.

While equilibrium-based thermodynamic processors are able to sample from deep latent variable probabilistic models, there are many applications where a fully visible model is preferred. There are classes of algorithms where sampling and training involve emulating diffusion in a landscape parameterized by a deep neural network. Such Machine Learning algorithms include Deep Energy-Based Models (Deep EBMs), Denoising Diffusion Probabilistic Models, Diffusion Recovery Likelihood Models, and Neural Stochastic Differential Equations. In some embodiments, mean-field inference techniques for neural networks on thermodynamic processors, a mean-field backpropagation to obtain gradients of such parameterized functions, and time-scale separated effective dynamics may be combined to enact this broader class of diffusion, EBM, DRL, NSDE, algorithms as hardware physics.

In a mean-field architecture, there may be K≥1 EBM blocks, where the expectation value of the output of a given EBM block is used as input for the next EBM through the use of relay oscillators. For example, xₗ= [symbol] yₗ [symbol] for EBM block l. The output y_{K} of the final EBM block satisfies [symbol] y [symbol] =f_{θ}(x). In deep neural diffusion, it is desired to sample the input

$$x ∼ {p}_{θ} ( x ) = \frac{{e}^{- {f}_{θ} ( x )}}{Z ( θ )}$$

by computing the gradient ∇ₓf_{θ}(x) using mean-field forwards and backwards propagation methods.

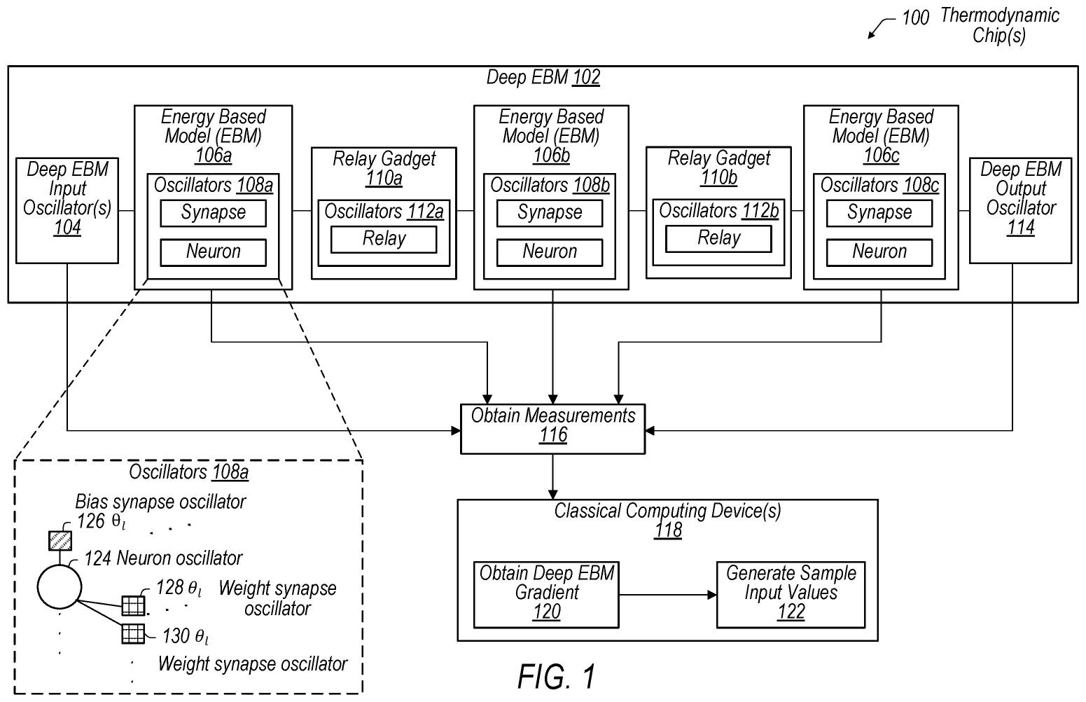

FIG. 1 is a high-level diagram illustrating a deep energy-based model (deep EBM) implemented on one or more thermodynamic chips, wherein a classical computing device determines gradients of the deep EBM and generates sample input values, according to some embodiments.

In some embodiments, deep EBM 102 may be implemented on one or more thermodynamic chips 100. In some embodiments, a deep EBM 102 may have multiple blocks of smaller EBMs (e.g., EBM 106a, 106b, and 106c), where the output of a given EBM block l (by way of example, say EBM 106a is the EBM block l) is denoted by yₗ(which is encoded in the position degrees of freedom of the oscillators ϕ_{y}_{ₗ}). The output yₗ may be coupled to one or more relay oscillators such that the input for EBM block l+1 (e.g., EBM 106b) is ϕₓ_{ₗ}= [symbol] ϕ_{y}_{ₗ} [symbol] . In other words, the input to the EBM block l+1 (e.g., ϕₓ_{ₗ}) is the expectation value of the output of the previous block (e.g., [symbol] ϕ_{y}_{ₗ} [symbol] ). For notational simplicity, the input to the deep EBM 102 may be denoted as x, which is encoded in the position degrees of freedom of the oscillators ϕₓ (e.g., deep EBM input oscillator(s) 104). The energy function of the conditional EBM of block l (e.g., EBM 106a) may be denoted as ε_{θ}_{ₗ}(yₗ₋₁). An EBM may be considered conditional wherein an input for the conditional EBM is based on output from another EBM. Furthermore, a deep EBM 102 may have a plurality of conditional EBMs (e.g., many blocks of EBMs). The total parameters of the deep EBM may be given by θ=(θ₁, . . . , θ_{K}) where θₗ are the parameters for the EBM in block l such as bias synapse oscillator 126, weight synapse oscillator 128 and weight synapse oscillator 130.

In some embodiments, a total of K≥1 EBM blocks may be used, and the output of the final EBM in block K may be y_{K} such that [symbol] y_{K} [symbol] =ƒ_{θ}(x). By way of example, EBM 106c may represent the final EBM in block K. Furthermore, a deep EBM is not constrained to three EBMs such as shown in FIG. 1. There may be any number of EBMs in a deep EBM to compute some function. In other words, the K EBM blocks may be used to compute some function ƒ_{θ}(x) using a mean-field approach, where the expectation value of the final output (e.g., deep EBM output oscillator 114) is equal to ƒ_{ƒ}(x), and where the inputs to each intermediate block is the expected value of the output of the previous EBM block (e.g., conditional EBMs).

In some embodiments, a deep EBM 102 may use mean-field forwards and backwards propagation steps to generate gradients used to sample input values x 122 using Langevin dynamics. For example, given a gradient with respect to input parameters x of a function implemented by the deep EBM (e.g., ∇ₓƒ_{θ}(x), which may also be referred to as deep EBM gradients for simplicity), an input x may may be sampled from an underlying distribution, wherein the underlying distribution may be represented by

$$x ∼ {p}_{θ} ( x ) = \frac{{e}^{- {f}_{θ} ( x )}}{Z ( θ )} ,$$

using a Langevin Markov chain Monte Carlo (MCMC) algorithm as

$${x}_{k + 1} = {x}_{k} - δ {∇}_{x} {f}_{θ} ( x ) + \sqrt{2 δ} {ξ}_{k} , \qquad ( equation 1 )$$

where ξₖ˜ [symbol] (0, l). In equation 1, the subscripts k and k+1 may indicate the Langevin MCMC step, and & may be the step size. Following equation 1, it may be desirable to obtain the deep EBM gradient 120 ∇ₓƒ_{θ}(x) using mean-field forwards and backwards approaches.

### Forwards Pass

As will be shown below for a backwards pass, the back-propagation step used to compute the gradient ∇ₓƒ_{θ}(x) (e.g., obtain deep EBM gradient 120) requires gradients of the form

$${𝔼 [ \frac{\partial {ε}_{{θ}_{l}} ( {y}_{l} \vert {x}_{l - 1} )}{\partial 〈 {y}_{l - 1}^{( j )} 〉} ]}_{{y}_{l} ∼ {p}_{{θ}_{l}} ( {y}_{l} \vert {x}_{l - 1} )} = {𝔼 [ \frac{\partial {ε}_{{θ}_{l}} ( {y}_{l} \vert {x}_{l - 1} )}{\partial {x}_{l - 1}^{( j )}} ]}_{{y}_{l} ∼ {p}_{{θ}_{l}} ( {y}_{l} \vert {x}_{l - 1} )} , \qquad ( equation 2 ) .$$

Such gradients of equation 2 (which may be referred to as gradients of an EBM with an unperturbed potential) may be stored in the position degrees of freedom of relay oscillators for all EBM blocks 1≤l≤K. Alternatively, oscillators of respective EBMs may be measured, wherein the measurements are stored on a classical computer and the gradients of the respective EBMs with an unperturbed potential may be calculated. Nevertheless, in the embodiments where relay oscillators are used to store gradients,

$${ϕ}_{{r}_{1}}^{( l , j )}$$

may be defined as a relay oscillator in a first set of relay oscillators whose position degree of freedom is static at the gradient given in equation 2.

### Backwards Pass

As discussed above, it may be desirable to compute gradients of the form

$$\frac{\partial {f}_{θ} ( x )}{\partial {x}^{( j )}} = \frac{\partial 〈 {y}_{K} 〉}{\partial {x}^{( j )}} \qquad ( equation 3 )$$

for all indices j spanning the size of the input vector x (e.g., there may be a plurality of inputs collectively represented as x). Using the chain rule may result in the following

$$\frac{\partial 〈 {y}_{K} 〉}{\partial {x}^{( j )}} = {\sum }_{{s}_{1} ∈ {𝒥}_{j}^{( 1 )}} \frac{\partial 〈 {y}_{K} 〉}{\partial 〈 {y}_{1}^{( {s}_{1} )} 〉} \frac{\partial 〈 {y}_{1}^{( {s}_{1} )} 〉}{\partial {x}^{( j )}} \qquad ( equation 4 and equation 5 )$$

$$\frac{\partial 〈 {y}_{K} 〉}{\partial 〈 {y}_{1}^{( {s}_{1} )} 〉} = {\sum }_{{s}_{2} ∈ {𝒥}_{{s}_{1}}^{( 2 )}} \frac{\partial 〈 {y}_{K} 〉}{\partial 〈 {y}_{2}^{( {s}_{2} )} 〉} \frac{\partial 〈 {y}_{2}^{( {s}_{2} )} 〉}{\partial 〈 {y}_{1}^{( {s}_{1} )} 〉}$$

up to

$$\frac{\partial 〈 {y}_{K} 〉}{\partial 〈 {y}_{K - 2}^{( {s}_{K - 2} )} 〉} = {\sum }_{{s}_{K - 1} ∈ {𝒥}_{{s}_{K - 2}}^{( K - 1 )}} \frac{\partial 〈 {y}_{K} 〉}{\partial 〈 {y}_{K - 1}^{( {s}_{K - 1} )} 〉} \frac{\partial 〈 {y}_{K - 1}^{( {s}_{K - 1} )} 〉}{\partial 〈 {y}_{K - 2}^{( {s}_{K - 2} )} 〉} \qquad ( equation 6 )$$

and where s∈

$${𝒥}_{j}^{( l )}$$

may include all indices for which the output nodes

$${y}_{l + 1}^{( s )}$$

of a next block are coupled to

$${y}_{l}^{( j )}$$

of a given block. Around the discussion of equation 26 it is shown that

$$\frac{\partial 〈 {y}_{l + 1}^{( s )} 〉}{\partial 〈 {y}_{l}^{( j )} 〉} = - {Cov ( {y}_{l + 1}^{( s )} , \frac{\partial {ε}_{{θ}_{l + 1}} ( {y}_{l + 1} \vert 〈 {y}_{l} 〉 )}{\partial 〈 {y}_{l}^{( j )} 〉} )}_{{y}_{l + 1}^{( s )} ∼ {p}_{{θ}_{l + 1}} ( {y}_{l + 1} \vert 〈 {y}_{l} 〉 )} , \qquad ( equation 7 ) .$$

For a backwards pass, energy functions of the EBMs may be perturbed. A perturbed energy function during the back-propagation step may be given as

$${\tilde{ε}}_{{θ}_{l}}^{( B )} ( {y}_{l} \vert 〈 {y}_{l - 1} 〉 ) = {ε}_{{θ}_{l}} ( {y}_{l} \vert 〈 {y}_{l - 1} 〉 ) + ϵ \tilde{V} ( {y}_{l} ) , \qquad ( equation 8 )$$

for ϵ<<1. Now using a mean-field relay oscillator method to store space averaged gradients in the position degrees of freedom of relay oscillators, let

$${ϕ}_{{r}_{2}}^{( l , j )}$$

be a relay oscillator of a second set of relay oscillators whose position degree of freedom is static at the gradient

$${I}_{2}^{( l , j )} ,$$

where

$${I}_{2}^{( l , j )}$$

is defined as

$${𝔼 [ \frac{\partial {\tilde{ε}}_{{θ}_{l}}^{( B )} ( {y}_{l} \vert 〈 {y}_{l - 1} 〉 )}{\partial 〈 {y}_{l - 1}^{( j )} 〉} ]}_{{y}_{l} ∼ {p}_{{θ}_{l}} ( {y}_{l} \vert {x}_{l - 1} )} = \int {dy}_{l} \frac{\partial {\tilde{ε}}_{{θ}_{l}}^{( B )} ( {y}_{l} \vert 〈 {y}_{l - 1} 〉 )}{\partial 〈 {y}_{l - 1}^{( j )} 〉} \frac{{e}^{- {ε}_{{θ}_{l}} ( {y}_{l} \vert 〈 {y}_{l - 1} 〉 ) - ϵ \tilde{V} ( {y}_{l} )}}{{\tilde{Z}}^{( B )}} ≡ {I}_{2}^{( l , j )} , \qquad ( equation 9 ) .$$

Taylor expanding equation 9 and keeping terms to leading order in ϵ, may result in

$${I}_{2}^{( l , j )} = 〈 \frac{\partial {ε}_{{θ}_{l}} ( {y}_{l} \vert 〈 {y}_{l - 1} 〉 )}{\partial 〈 {y}_{l - 1}^{( j )} 〉} 〉 - ϵCov ( \tilde{V} ( {y}_{l} ) , \frac{\partial {ε}_{{θ}_{l}} ( {y}_{l} \vert 〈 {y}_{l - 1} 〉 )}{\partial 〈 {y}_{l - 1}^{( j )} 〉} ) + 𝒪 ( {ϵ}^{2} ) , \qquad ( equation 10 ) .$$

Now, according to some embodiments, a perturbed potential \tilde{V}(yₗ), such as in equation 8, may be set as

$$\tilde{V} ( {y}_{l} ) = \frac{\partial 〈 {y}_{K} 〉}{\partial 〈 {y}_{l} 〉} \cdot {y}_{l} , \qquad ( equation 11 )$$

if <K and \tilde{V}(y_{K})=y_{K} for l=K. Inserting equation 11 into equation 10 may result in

$$\begin{matrix}{I}_{2}^{( l , j )} - 〈 \frac{\partial {ε}_{{θ}_{l}} ( {y}_{l} \vert 〈 {y}_{l - 1} 〉 )}{\partial 〈 {y}_{l - 1}^{( j )} 〉} 〉 = - ϵ \frac{\partial 〈 {y}_{K} 〉}{\partial 〈 {y}_{l} 〉} \cdot Cov ( {y}_{l} , \frac{\partial {ε}_{{θ}_{l}} ( {y}_{l} \vert 〈 {y}_{l - 1} 〉 )}{\partial 〈 {y}_{l - 1}^{( j )} 〉} ) + 𝒪 ( {ϵ}^{2} ) \\ = ϵ {\sum }_{s ∈ {𝒥}_{j}^{( l - 1 )}} \frac{\partial 〈 {y}_{K} 〉}{\partial 〈 {y}_{l}^{( s )} 〉} \frac{\partial 〈 {y}_{l}^{( s )} 〉}{\partial 〈 {y}_{l - 1}^{( j )} 〉} + 𝒪 ( {ϵ}^{2} ) \\ = ϵ \frac{\partial 〈 {y}_{K} 〉}{\partial 〈 {y}_{l - 1}^{( j )} 〉} + 𝒪 ( {ϵ}^{2} )\end{matrix} , \qquad ( equation 12 )$$

which (up to the ϵ pre-factor) is the desired gradient for EBM block l.

Utilizing the result leading to equation 12, a third relay oscillator

$${ϕ}_{{r}_{3}}^{( l , j )}$$

of a set of relay oscillators is introduced with mass m_{f} and frequency ω_{f} which is coupled to relay oscillators

$${ϕ}_{{r}_{1}}^{( l , j )} and {ϕ}_{{r}_{2}}^{( l , j )}$$

using the potential

$${V}_{BKM}^{( 3 )} = \frac{1}{2} {m}_{f} {{ω}_{f}^{2} ( {ϕ}_{{r}_{3}}^{( l , j )} )}^{2} + {λ}_{3} ( t ) {( {ϕ}_{{r}_{3}}^{( l , j )} - {c}_{1} ( {ϕ}_{{r}_{2}}^{( l , j )} - {ϕ}_{{r}_{1}}^{( l , j )} ) )}^{2} . \qquad ( equation 13 ) .$$

Note that relay oscillator

$${ϕ}_{{r}_{1}}^{( l , j )}$$

is static according to equation 2 and

$${ϕ}_{{r}_{2}}^{( l , j )}$$

is static according to equation 9. By setting the coupling coefficient λ₃ to

$${λ}_{3} ≫ \frac{1}{2} {m}_{f} {ω}_{f}^{2} , \qquad ( equation 14 )$$

in equation 13 and the coupling constant c₁=1/ϵ, and following equation 12, relay oscillator

$${ϕ}_{{r}_{3}}^{( l , j )}$$

reaches equilibrium at

$$\frac{\partial 〈 {y}_{K} 〉}{\partial 〈 {y}_{l - 1}^{( j )} 〉} ,$$

according to some embodiments. Relay oscillator

$${ϕ}_{{r}_{3}}^{( l , j )}$$

may then be coupled to yₗ to create the perturbed potential \tilde{V}(yₗ) in equation 11. By utilizing such couplings, the gradients

$${I}_{2}^{( l - 1 , j )}$$

for the EBM in block l−1 may be computed. Continuing this way until l=1, the position degrees of freedom of the relay oscillators

$${ϕ}_{{r}_{3}}^{( 1 , j )}$$

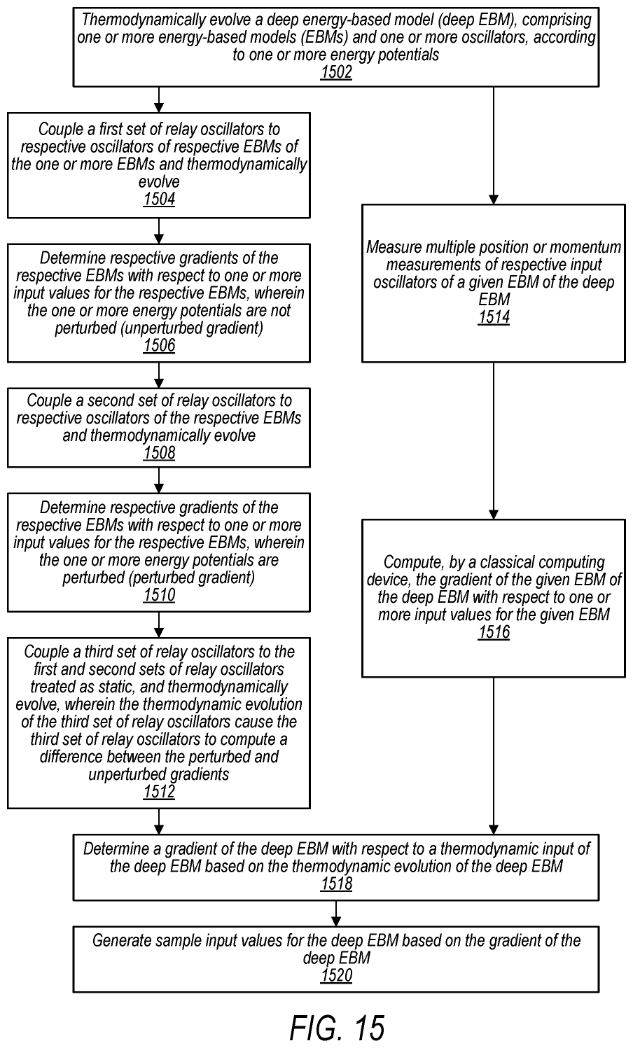

will be static at the gradients in equation 3, according to some embodiments. See FIG. 15. By measuring the position degrees of freedom of

$${ϕ}_{{r}_{3}}^{( 1 , j )}$$

for all indices j and sending the measurement results to a classical computing device(s) 118 (e.g., an external classical post-processing device), such a device will then contain the gradient of the deep EBM, ∇ₓƒ_{θ}(x).

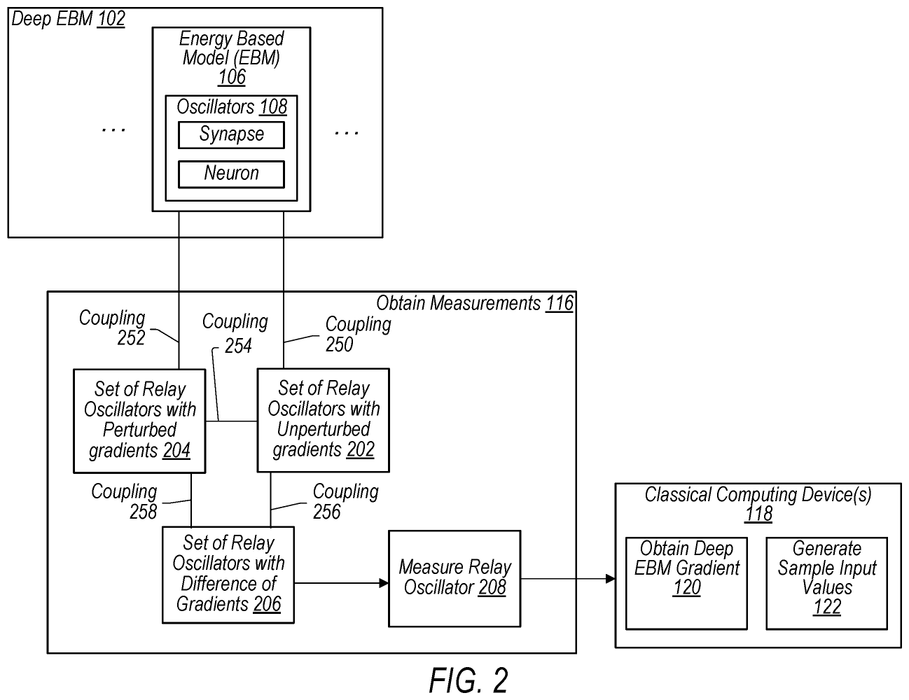

FIG. 2 is a high-level diagram illustrating sets of relay oscillators configured to be coupled to oscillators of a deep energy-based model (deep EBM), wherein the coupling enables gradient terms to be obtained to emulate deep neural diffusion of a deep EBM, according to some embodiments.

In some embodiments, an example of hardware and a process for a time-scale separated fully programmable deep neural diffusion backwards propagation (such as described above) may be described as follows.

Let

$${ϕ}_{{r}_{1}}^{( l , j )}$$

be a relay oscillator of a first set of relay oscillators whose position degree of freedom is static at the gradient

$$〈 \frac{\partial {ε}_{{θ}_{l}} ( {y}_{l} \vert {x}_{l} )}{\partial 〈 {y}_{l - 1}^{( j )} 〉} 〉$$

obtained during a forwards pass (e.g., set of relay oscillators with unperturbed gradients 202). Such relay oscillators exist in the first set of relay oscillators for each 1≤l≤K (and each index j for a given layer). Coupling 250 may enable the set of relay oscillators with unperturbed gradients 202 to obtain the perturbed gradients.

Backwards pass: Let

$${\tilde{ε}}_{{θ}_{l}}^{( B )} ( {y}_{l} \vert 〈 {y}_{l - 1} 〉 )$$

be the potential energy used for EBM block l given in equation 8.

For each block l of block K to block 1, the following steps may be performed.

Step 1: If l=K, set \tilde{V}(y_{K})=y_{K}. Otherwise set

$$\tilde{V} ( {y}_{l} ) = \frac{\partial 〈 {y}_{K} 〉}{\partial 〈 {y}_{l} 〉} \cdot {y}_{l} ,$$

where the vector

$$\frac{\partial 〈 {y}_{K} 〉}{\partial 〈 {y}_{l} 〉}$$

is encoded in the position degree of freedom of the relay oscillators

$${ϕ}_{{r}_{3}}^{( l + 1 , j )}$$

computed in the previous block (e.g., set of relay oscillators with difference of gradients 206). In this case, \tilde{V}(yₗ) is set by coupling

$${ϕ}_{{r}_{3}}^{( l + 1 , j )} to {y}_{l}^{( j )} .$$

Step 2: Use a mean-field relay oscillator method such that the relay oscillators with position degree of freedom

$${ϕ}_{{r}_{2}}^{( l , j )}$$

(set of relay oscillators with perturbed gradients 204) remains static at

$${E [ \frac{\partial {\tilde{ε}}_{{θ}_{l}}^{( B )} ( {y}_{l} \vert 〈 {y}_{l - 1} 〉 )}{\partial 〈 {y}_{l - 1}^{( j )} 〉} ]}_{{y}_{l} ∼ {p}_{{θ}_{l}} ( {y}_{l} \vert {x}_{l - 1} )} .$$

Step 3: Couple a third batch of relay oscillators

$${ϕ}_{{r}_{3}}^{( l , j )}$$

(for each j) with masses m_{f} and frequencies ω_{f} to

$${ϕ}_{{r}_{2}}^{( l , j )} and {ϕ}_{{r}_{1}}^{( l , j )}$$

as in equation 13 (with

$${ϕ}_{{r}_{2}}^{( l , j )} and {ϕ}_{{r}_{1}}^{( l , j )}$$

treated as static) and where the coupling term is

$${λ}_{3} ( t ) {( {ϕ}_{{r}_{3}}^{( l , j )} - {c}_{1} ( {ϕ}_{{r}_{2}}^{( l , j )} - {ϕ}_{{r}_{1}}^{( l , j )} ) )}^{2} .$$

Step 4: Set

$${λ}_{3} >> \frac{1}{2} {m}_{f} {ω}_{f}^{2}$$

and c₁=1/ϵ. Tune the product

$${m}_{f} {ω}_{f}^{2}$$

such that the position degree of freedom of

$${ϕ}_{{r}_{3}}^{( l , j )}$$

remains static at

$$\frac{\partial 〈 {y}_{K} 〉}{\partial 〈 {y}_{l - 1}^{( j )} 〉} .$$

With the steps above performed for each block l of block K to block 1, the system may measure the position degrees of freedom of the relay oscillators

$${ϕ}_{{r}_{3}}^{( 1 , j )}$$

for each J (where j spans the size of the input vector x). Such measurements correspond to the desired gradients in equation 3, the deep EBM gradients.

Send the measurement results to an external classical post-processing device.

### Calculation of the Gradient of the Loss Function for Mean-Field Deep EBMs

According to some embodiments, a detailed calculation of relevant gradients needed to perform the backwards propagation may be described as follows, starting with

$$\frac{\partial 〈 {y}_{l} 〉}{\partial {θ}_{l}^{( j )}} .$$

Using the definition of an expectation value results in

$$\frac{\partial 〈 {y}_{l} 〉}{\partial {θ}_{l}^{( j )}} = \int d {y}_{l} {y}_{l} \frac{\partial }{\partial {θ}_{l}^{( j )}} p ( {y}_{l} \vert {θ}_{l} , {x}_{l - 1} ) . \qquad ( equation 15 )$$

Using the definition of the probability distribution for conditional EBMs may result in

$$\begin{matrix}\frac{\partial }{\partial {θ}_{l}^{( j )}} p ( {y}_{l} \vert {θ}_{l} , {x}_{l - 1} ) = \frac{\partial }{\partial {θ}_{l}^{( j )}} \frac{{e}^{- {ℰ}_{{0}_{l}} ( {y}_{l} \vert {x}_{l - 1} )}}{Z ( {x}_{l - 1} , {θ}_{l} )} \\ = - p ( {y}_{l} \vert {θ}_{l} , {x}_{l - 1} ) \frac{\partial {ℰ}_{{θ}_{l}} ( {y}_{l} \vert {x}_{l - 1} )}{\partial {θ}_{l}^{( j )}} - \frac{{e}^{- {ℰ}_{{θ}_{l}} ( {y}_{l} \vert {x}_{l - 1} )}}{{Z ( {x}_{l - 1} , {θ}_{l} )}^{2}} \frac{\partial Z ( {x}_{l - 1} , {θ}_{l} )}{\partial {θ}_{l}^{0 )}} \\ = - p ( {y}_{l} \vert {θ}_{l} , {x}_{l - 1} ) ( \frac{\partial {ℰ}_{{θ}_{l}} ( {y}_{l} \vert {x}_{l - 1} )}{\partial {θ}_{l}^{( j )}} + \frac{1}{Z ( {x}_{l - 1} , {θ}_{l} )} \frac{\partial Z ( {x}_{l - 1} , {θ}_{l} )}{\partial {θ}_{l}^{( j )}} ) .\end{matrix} \qquad ( equation 16 )$$

Now, it may follow that

$$\begin{matrix}\frac{\partial Z ( {x}_{l - 1} , {θ}_{l} )}{\partial {θ}_{l}^{( j )}} = \int dy \frac{\partial {e}^{- {ℰ}_{{θ}_{l}} ( y \vert {x}_{l - 1} )}}{\partial {θ}_{l}^{( j )}} \\ = - \int dy \frac{\partial {ℰ}_{{θ}_{l}} ( y \vert {x}_{l - 1} )}{\partial {θ}_{l}^{( j )}} {e}^{- {ℰ}_{{θ}_{l}} ( y \vert {x}_{l - 1} )} ,\end{matrix} \qquad ( equation 17 )$$

so that equation 16 becomes

$$\frac{\partial }{\partial {θ}_{l}^{( j )}} p ( {y}_{l} \vert {θ}_{l} , {x}_{l - 1} ) = \text{} - p ( {y}_{l} \vert {θ}_{l} , {x}_{l - 1} ) ( \frac{\partial {ℰ}_{{θ}_{l}} ( {y}_{l} \vert {x}_{l - 1} )}{\partial {θ}_{l}^{( j )}} - {〈 \frac{\partial {ℰ}_{{θ}_{l}} ( {y}_{l} \vert {x}_{l - 1} )}{\partial {θ}_{l}^{( j )}} 〉}_{p ( {y}_{l} \vert {θ}_{l} {x}_{l - 1} )} ) . \qquad ( equation 18 )$$

Inserting equation 18 into equation 15 may result in

$$\frac{\partial 〈 {y}_{l} 〉}{\partial {θ}_{l}^{( j )}} = \text{} - \int d {y}_{l} {y}_{l} \frac{\partial {ℰ}_{{θ}_{l}} ( {y}_{l} \vert {x}_{l - 1} )}{\partial {θ}_{l}^{( j )}} p ( {y}_{l} \vert {θ}_{l} , {x}_{l - 1} ) + \int {dy}_{l}^{( t )} {y}_{l} p ( {y}_{l} \vert {θ}_{l} , {x}_{l - 1} ) {〈 \frac{\partial {ℰ}_{{θ}_{l}} ( {y}_{l} \vert {x}_{l - 1} )}{\partial {θ}_{l}^{( j )}} 〉}_{p ( {y}_{l} \vert {θ}_{l} , {x}_{l - 1} )} = \text{} - {〈 {y}_{l} \frac{\partial {ℰ}_{{θ}_{l}} ( {y}_{l} \vert {x}_{l - 1} )}{\partial {θ}_{l}^{( j )}} 〉}_{p ( {y}_{l} \vert {θ}_{l} {x}_{l - 1} )} + {〈 {y}_{l} 〉}_{p ( {y}_{l} \vert {θ}_{l} , {x}_{l - 1} )} {〈 \frac{\partial {ℰ}_{{θ}_{l}} {y}_{l} \vert {x}_{l - 1} )}{\partial {θ}_{l}^{( j )}} 〉}_{p ( {y}_{l} \vert {θ}_{l} , {x}_{l - 1} )} = \text{} - Cov ( \text{} {y}_{l} , \frac{\partial {ℰ}_{{θ}_{l}} ( {y}_{l} \vert {x}_{l - 1} )}{\partial {θ}_{l}^{( j )}} ) , \qquad ( equation 19 )$$

where the covariance of two random variables X and Y is defined as

$$Cov ( X , Y ) = 〈 XY 〉 - 〈 X 〉 〈 Y 〉 . \qquad ( equation 20 )$$

Therefore, the term

$$\frac{\partial 〈 {y}_{l} 〉}{\partial {θ}_{l}^{( j )}}$$

can be obtained by computing the covariance between the output of the EBM in layer l and the gradient of the corresponding potential energy with respect to the parameters.

Now computing the term

$$\frac{\partial L}{\partial 〈 {y}_{l}^{( j )} 〉}$$

(where without loss of generality the index i is removed) is discussed. Some embodiments may start with the final layer, and then consider the hidden layers of the deep neural network. For the final layer, using

$${L}_{i} = \frac{1}{2} {( {y}_{i}^{( t )} - 〈 {y}_{K}^{( i )} 〉 )}^{2} , \qquad ( equation 21 )$$

may result in

$$\frac{\partial L}{\partial 〈 {y}_{K}^{( 1 )} 〉} = - ( {y}^{( t )} - 〈 {y}_{K} 〉 ) , \qquad ( equation 22 )$$

where the superscript index is removed in (y_{K}) since models with a single output in the final layer is considered, according to some embodiments. For the hidden layer, the chain rule may be used to result in

$$\frac{\partial L}{\partial 〈 {y}_{l}^{( j )} 〉} = {\sum }_{s ∈ {𝒥}_{j}^{( l )}} \frac{\partial L}{\partial 〈 {y}_{l + 1}^{( s )} 〉} \frac{\partial 〈 {y}_{l + 1}^{( s )} 〉}{\partial 〈 {y}_{l}^{( j )} 〉} , \qquad ( equation 23 )$$

where the set

$${𝒥}_{j}^{( l )}$$

includes an indices for which the output nodes

$${y}_{l + 1}^{( s )}$$

are coupled to

$${x}_{l}^{( j )} = 〈 {y}_{l}^{( j )} 〉 .$$

The second term on the right-hand side of equation 23 is computed as follows. First the derivative of the expectation value may be expressed explicitly as

$$\frac{\partial 〈 {y}_{l + 1}^{( s )} 〉}{\partial 〈 {y}_{l}^{( j )} 〉} = \int d {y}_{l + 1}^{( s )} {y}_{l + 1}^{( s )} \frac{\partial }{\partial 〈 {y}_{l}^{( j )} 〉} \frac{{e}^{- {ℰ}_{{θ}_{l + 1}} ( {y}_{l + 1} \vert 〈 {y}_{l} 〉 )}}{Z ( 〈 {y}_{l} 〉 , {θ}_{l + 1} )} . \qquad ( equation 24 )$$

Importantly, note that the input to the EBM block in layer l+1 is xₗ= [symbol] yₗ [symbol] since the relay oscillator imparts its state to xₗ. Thus, xₗ may be replaced with [symbol] yₗ [symbol] in equation 24. Now, computing the derivative inequation 24 may result in

$$\frac{\partial }{\partial 〈 {y}_{l}^{( j )} 〉} \frac{{e}^{- {ℰ}_{{θ}_{l + 1}} ( {y}_{l + 1} \vert 〈 {y}_{l} 〉 )}}{Z ( 〈 {y}_{l} 〉 , {θ}_{l + 1} )} = \text{} - p ( {y}_{l + 1} \vert 〈 {y}_{l} 〉 , {θ}_{l + 1} ) ( \frac{\partial {ℰ}_{{θ}_{l + 1}} ( {y}_{l + 1} \vert 〈 {y}_{l} 〉 )}{\partial 〈 {y}_{l}^{( j )} 〉} - 〈 \frac{\partial {ℰ}_{{θ}_{l + 1}} ( {y}_{l + 1} \vert 〈 {y}_{l} 〉 )}{\partial 〈 {y}_{l}^{( j )} 〉} 〉 ) . \qquad ( equation 25 )$$

Inserting equation 25 into equation 24 may result in

$$\frac{\partial 〈 {y}_{l + 1}^{( s )} 〉}{\partial 〈 {y}_{l}^{( j )} 〉} = - Cov ( {y}_{l + 1}^{( s )} , \frac{\partial {ℰ}_{{θ}_{l + 1}} ( {y}_{l + 1} \vert 〈 {y}_{l} 〉 )}{\partial 〈 {y}_{l}^{( j )} 〉} ) , \qquad ( equation 26 )$$

where similar methods that went into deriving equation 19 are used.

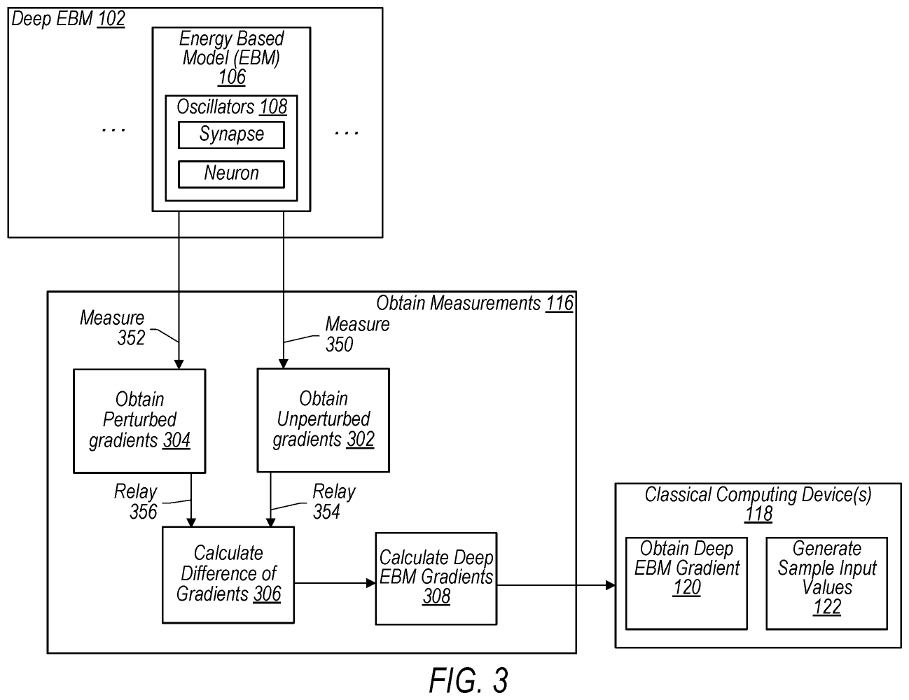

FIG. 3 is a high-level diagram illustrating oscillators of a deep energy-based model (deep EBM) configured to be measured, wherein the measurements enable gradient terms to be obtained to emulate deep neural diffusion of a deep EBM, according to some embodiments.

In some embodiments, EBMs 106 of the deep EBM may have oscillators 108 that are configured to be measured. For example, measurements of input or output neuron oscillators may be used to determine gradients and differences of gradients. Measure 350 may indicate measurements of neuron oscillators, wherein the measurements are used to obtain perturbed gradients 302. Measure 352 may indicate measurements of neuron oscillators, wherein the measurements are used to obtain unperturbed gradients 304. The unperturbed and perturbed gradients may be calculated on a classical computing device and based on the measurements. With the gradients obtained and calculated, the gradients may be relayed to a classical computing device as illustrated by relay 356 and 354. Then the classical computing device may calculate a difference of gradients 306. The difference of gradients may be used to calculate deep EBM gradients 308.

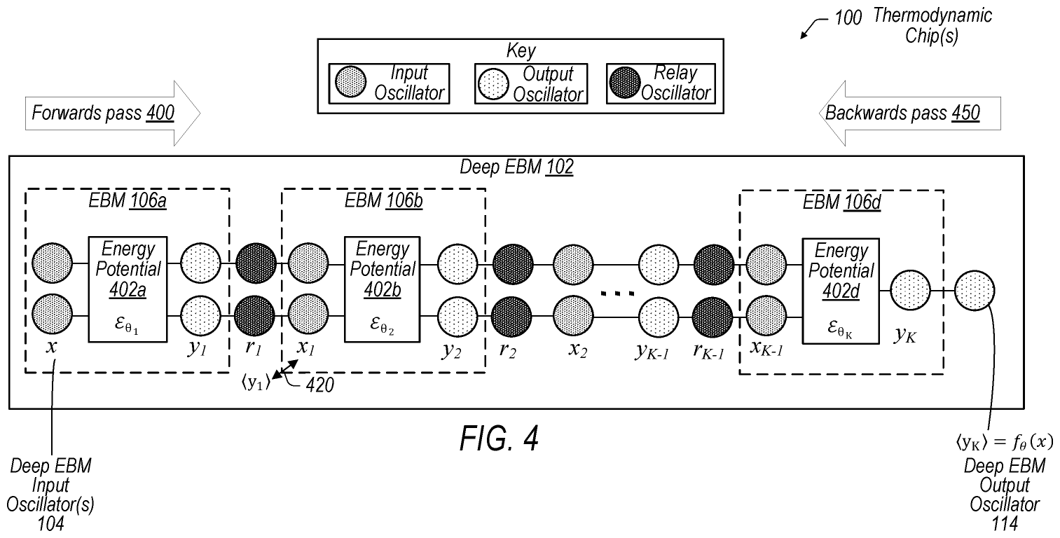

FIG. 4 is a high-level diagram illustrating a deep energy-based model (EBM), which may be used to sample input values, according to some embodiments.

In some embodiments, a deep energy-based model (EBM) may emulate deep neural diffusion using a mean-field forwards (e.g., forwards pass 400) and backwards propagation (e.g., backwards pass 450) method. For example, the expectation value of the output of a given EBM block (e.g., EBM 106a) may be used as an input to the next block (EBM 106b). The parameters (e.g., synapses of oscillators 108a-c such as weights and biases) of energy potentials 402a-d may be fixed. Gradients of the energy function in each EBM block 102a-d may be stored in the position degrees of freedom of one or more relay oscillators using a mean-field relay oscillator protocol during both the forwards (400) and backwards (450) pass. However, during the backwards pass 450, a perturbation to the energy potential 402a-d in each EBM block 106a-d may be turned on. The perturbed potential may be achieved through a linear coupling between relay oscillators that encode the relevant gradients and output neurons of the EBM blocks.

In some embodiments, a deep EBM may have deep EBM input oscillator(s) 104 as part of a first EBM block such as EBM 106a. Thermodynamic information may be processed from one EBM to the next, wherein a deep EBM output oscillator 114 encodes an output of a function implemented by the deep EBM. As illustrated by 420, the input of an EBM may be the expected value of an output oscillator of a previous EBM.

FIG. 5 is a diagram illustrating hardware components that may be used to implement oscillators of energy-based models (EBMs), as well as two different example hardware configurations of a relay oscillator that have a time-dependent mass or a time-dependent frequency, respectively, according to some embodiments.

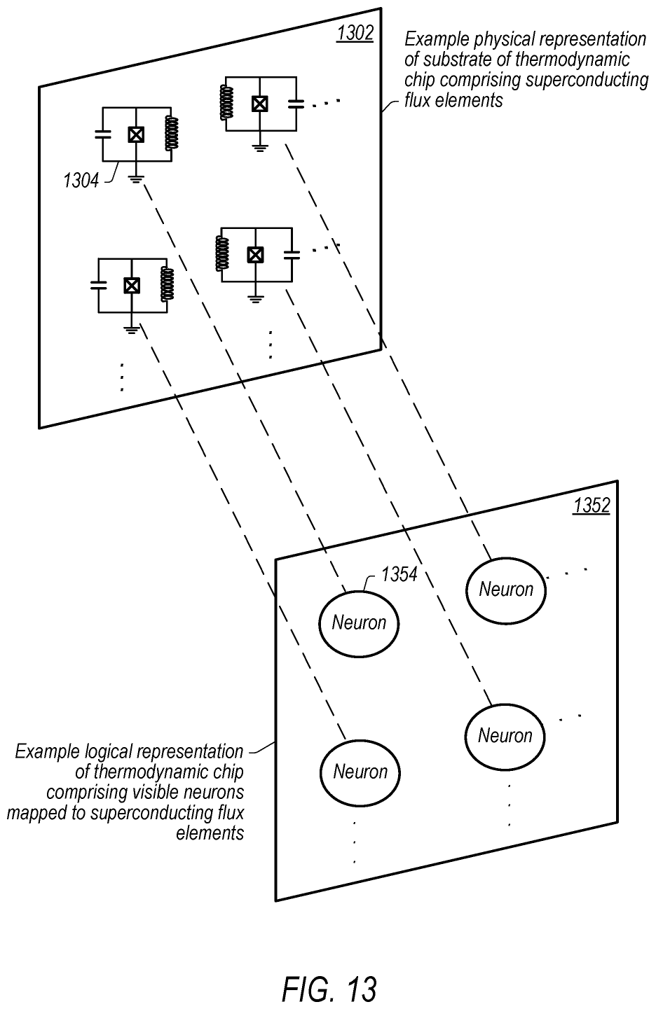

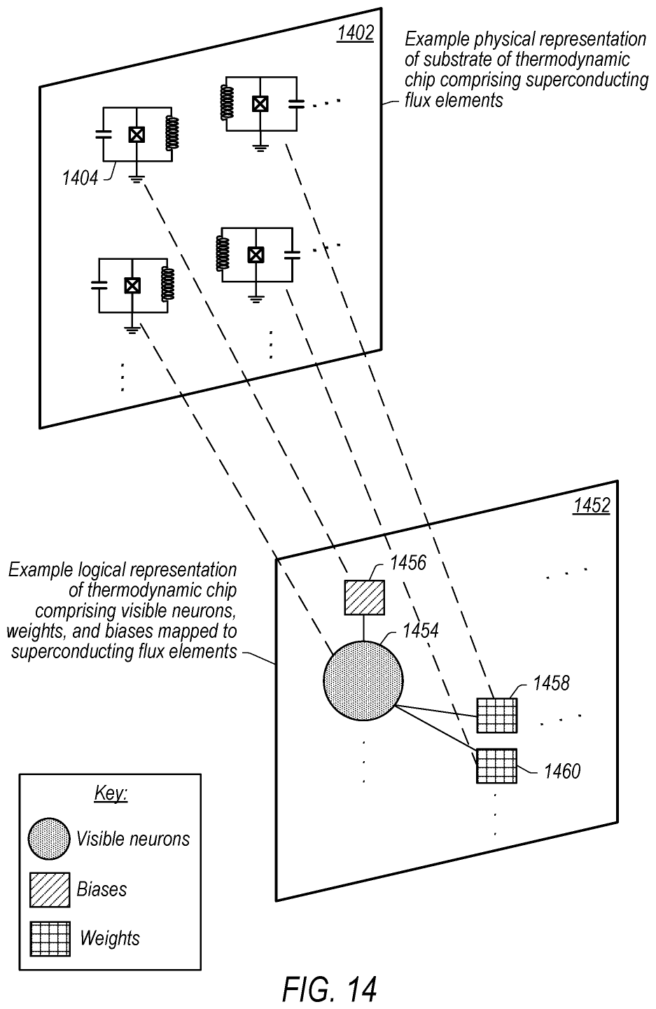

In some embodiments, each of the oscillators of the first energy-based model 106a and the second energy-based model 106b, may be implemented using superconducting circuit elements, such as shown in FIG. 5. These superconducting circuit elements may be used to implement oscillators that are mapped to visible or hidden neurons of the first or second energy-based model (e.g., 108a and 104b). Also, such oscillators may be mapped to synapses (e.g. weights or biases) of the first or second energy-based model. FIGS. 13-14 provide additional details regarding the mappings and hardware configurations used to implement example energy-based models. Also, as shown in FIG. 5 superconducting circuit elements may be used to implement the bias oscillator 506.

However, slightly different superconducting circuits may be used to implement the relay oscillator. In some embodiments a relay gadget 110a or 110b may comprise a plurality of relay oscillators such as relay oscillator 112a, wherein an expectation value of output oscillator 510 may be relayed to input oscillator 512. For example, circuit 502 shows an example implementation circuit for the relay oscillator 112a, wherein the circuit 502 implements a time-dependent frequency that can be controlled by controller 508. As another alternative, circuit 504 shows an example implementation circuit for the relay oscillator 112a, wherein the circuit 504 implements a time-dependent mass that can be controlled by controller 508.

In some embodiments, the relay gadget does not include a bias oscillator 506.

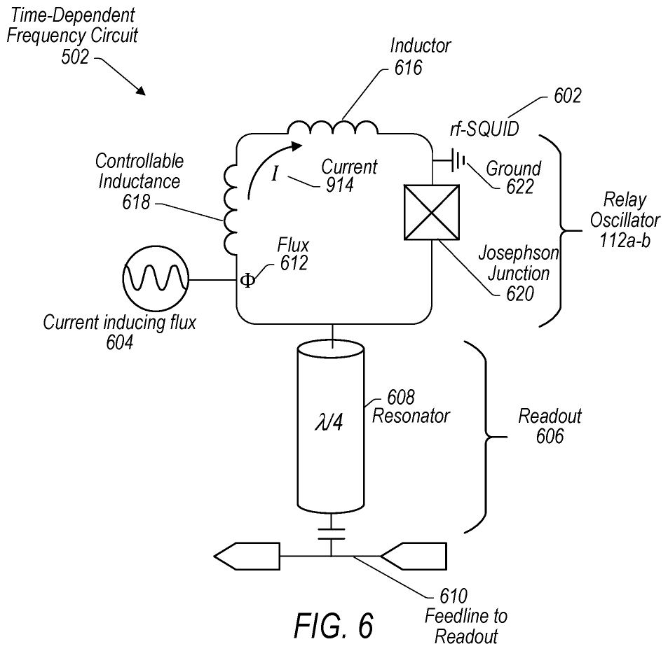

FIG. 6 is a diagram providing additional details regarding a hardware configuration used to implement a relay oscillator with a time-dependent frequency, according to some embodiments.

In some embodiments, a superconducting quantum interference device (SQUID) can be used in a circuit used to implement a relay oscillator with time-dependent frequency along with a controllable current line that induces a flux in the circuit. For example, time-dependent frequency circuit 502 includes rf-SQUID 602 and current line 604 that induces flux 612. Note the added flux 612 causes adjustments to the circuit flux 618 and current 614. The rf-SQUID 602 and current inducing flux 604 can be treated as a flux-tunable inductor, wherein changing the inductance of a LC-resonator changes the frequency of the time-dependent frequency circuit 502. In order to make the frequency time-dependent, a time dependent flux bias may be applied to a SQUID terminated resonator, such as shown in FIG. 6. In some embodiments, time-dependent frequency circuit 602 also includes Josephson junction 620 which is grounded 622. In some embodiments, the Josephson junction 620 and inductor 616 (along with controllable inductor 618) may form a part of relay oscillator 112a-bor relay oscillators in set of relay oscillators 202, 204, or 206. For Note that relay oscillator 112a-b may refer to any relay oscillator referenced herein. Note that in some embodiments relay oscillator 112a-b further includes a capacitor in parallel with the inductance and Josephson junction. However, for simplification purposes, the capacitor is not shown in FIG. 6.

In some embodiments, a value of the relay oscillator 112a-b may be read via readout 606. For example, a position degree of freedom of the relay oscillator 112a-b may be readout via readout 606. In some embodiments, readout 606 includes a resonator 608 which may have a length corresponding to ¼ the wavelength of the signal being readout from the relay oscillator 112a-b. Also, readout 606 may include feedline 610.

Note that inducing the flux in the time-dependent frequency circuit 502 via the current line 604 and resulting induced flux 612 allows for the Josephson inductance 618 to be tuned. This inductance is in series with the resonator inductance 616 so it simply adds to the L term of the LC oscillator. In the time-dependent frequency circuit 502 shown in FIG. 6 there is a voltage antinode at the capacitor below the resonator 606 and a voltage node as the SQUID end, which is grounded.

In some embodiments, the following function may be used for the time-dependent frequency:

$${ω}_{r} ( t ) = {ω}_{f}^{( r )} σ ( {k}_{r} ( t - {t}_{r} ) ) + {ω}_{r}$$

When a time-dependent frequency is used, the equation of motion for the average position of the relay oscillator 112a-b becomes:

$${m}_{r} \frac{{d}^{2} {ϕ}_{r}}{{dt}^{2}} + γ {m}_{r} \frac{d {ϕ}_{r}}{dt} = \text{} - ( - 2 {λ}_{A} ( t ) ( {ϕ}_{y} - {ϕ}_{r} ) + {λ}_{B} ( t ) {ϕ}_{b} + {λ}_{X} ( t ) {ϕ}_{x} + {m}_{r} {ω}_{r}^{2} ( t ) {ϕ}_{r} ) + \sqrt{2 {m}_{r} ( t ) {k}_{B} T} \frac{d {W}_{t}^{( r )}}{dt} \\ Or$$

$${m}_{r} \frac{{d}^{2} {ϕ}_{r}}{d {t}^{2}} + γ {m}_{r} \frac{d {ϕ}_{r}}{d t} = \text{} - ( - 2 {λ}_{A} ( t ) ( {ϕ}_{y} - {ϕ}_{r} ) - 2 {λ}_{B} ( t ) ( {ϕ}_{r} - {ϕ}_{b} ) + 2 {λ}_{X} ( t ) ( {ϕ}_{x} - {ϕ}_{r} ) + {m}_{r} {ω}_{r}^{2} ( t ) {ϕ}_{r} ) + \sqrt{2 {m}_{r} ( t ) {k}_{B} T} \frac{d {W}_{t}^{( r )}}{dt}$$

Note that since frequency is a function of capacitance and inductance, e.g.

$$( ω = \frac{1}{\sqrt{LC}} ) ,$$

by adjusting the inductance (L), the frequency of the circuit can be controlled. For example, as discussed above, a SQUID can be treated as a flux-tunable inductor, and by changing the inductance of the flux-tunable inductor, the inductance of an LC resonator can be changed, which also changes the LC resonator's frequency. For example, a time dependent flux bias can be applied to a SQUID terminated resonator.

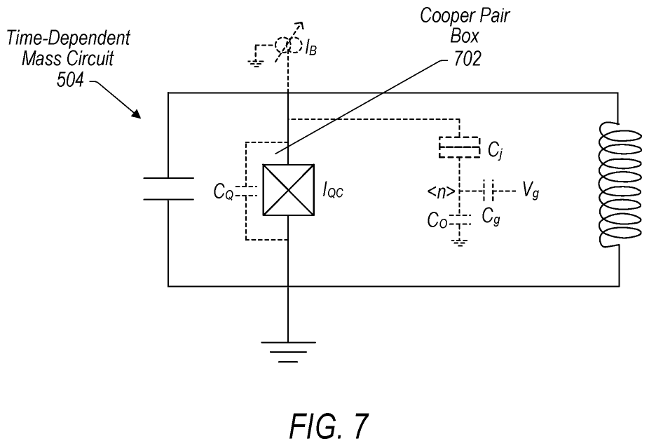

FIG. 7 is a diagram providing additional details regarding a hardware configuration used to implement a relay oscillator with a time-dependent mass, according to some embodiments.

A mass of an oscillator, is given by

$$m = {ϕ}_{0}^{2} C ,$$

where C is the capacitance of the circuit used to implement the oscillator and ϕ₀=h/2e is the reduced magnetic flux of the circuit used to implement the oscillator, e.g. a constant. Also, e is the elementary charge and h is Planck's constant. In some embodiments, a Cooper-pair box, such as Cooper-pair box 702, may be used to change the capacitance of the circuit. This allows the oscillator mass to change as a function of time, in response to control signals from a controller. The gate volage modulates the charge transfer through the small junction in the Cooper-pair box, thus leading to a gate-dependent capacitance.

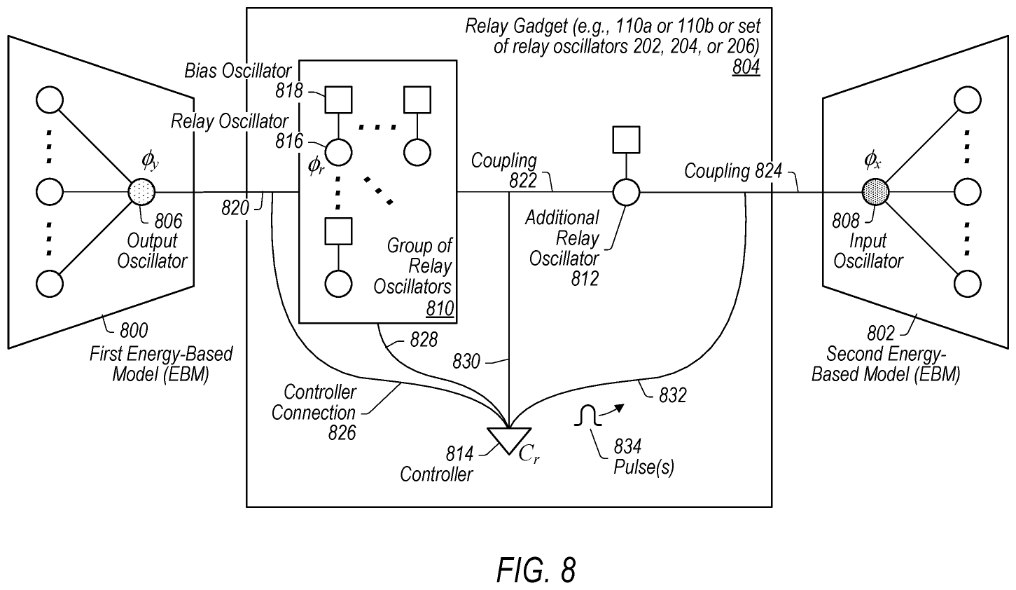

FIG. 8 is a high-level diagram illustrating an output oscillator, an input oscillator, and a relay gadget, wherein the relay gadget comprises a group of relay oscillators and is configured to relay thermodynamic information between the output oscillator and the input oscillator and includes bias oscillators, according to some embodiments.

In some embodiments, thermodynamic information is relayed from a first energy-based model (EBM) 800 to a second energy-based model (EBM) 802 via relay gadget 804 (e.g., 106a or 106b). The thermodynamic information of EBM 800 is outputted via output oscillator 806 and inputted into input oscillator 808 via relay gadget 804. The thermodynamic information may include, for example, samples of thermodynamic equilibrium of output oscillator 806, or the expectation value of the output oscillator 806. The expectation value is at least derivable based on samples values of the output oscillator 806. Output oscillator 806 may be governed by a potential wherein the potential follows a single-well potential, double-well potential, multi-well potential, or any generic potential that may be engineered. The output oscillator 806 may also be coupled to other oscillators belonging to EBM 800.

In some embodiments, an expectation value of one or more degrees of freedom of output oscillator 806 may be influenced by a potential of output oscillator 806 as well as couplings between output oscillator 806 and one or more oscillators belonging to first energy-based model 800. Potentials governing the dynamics of the output oscillator 806 may have multiple wells. With generic arbitrary potentials (e.g. multiple wells) and coupling between output oscillator 806 and one or more oscillators belonging to first energy-based model 800, the position degrees of freedom of the output oscillators can hop between wells. As described herein, a relay gadget provides a solution to approximate an expectation value of the output oscillator. Furthermore, utilizing the expectation value allows for forwards and backwards propagation. For example, using an approximated expectation value in forwards and backwards propagation may provide better results than using a sample value, as the expectation value better represents the state of the oscillator whose degree of freedom value is being relayed to a second oscillator.

Relay gadget 804 comprises a group of relay oscillators 810 and an additional relay oscillator 812. The group of relay oscillators 810 comprises one or more relay oscillators arranged with respective bias oscillators (e.g., relay oscillator 816 arranged with bias oscillator 818). As described later, relay oscillators in oscillator group 810 may be configured and coupled in various ways (e.g. temporally and spatially) to transfer thermodynamic information. The additional relay oscillator 812 is connected to bias oscillator 820. As discussed later, the additional relay oscillator 812 may be configured and coupled in various ways to transfer thermodynamic information. For example, the group of relay oscillators 810 transfers thermodynamic information to additional relay oscillator 812 via coupling 822. Coupling 822 may be controlled by on-chip classical controller 814.

Output oscillator 806 is coupled to the one or more relay oscillators of the group of relay oscillators 810 via on-chip classical controller 814. On-chip classical controller 814 may send a pulse or a group of pulses to cause couplings between oscillators (e.g., coupling between output oscillator 806 and relay oscillator 816) or relay oscillators like 816 and a bias oscillator like 818 via 828. Coupling is represented by coupling 820, 822, 824 and oscillators may be coupled or not coupled. When coupling is on, parameters of respective coupled oscillators affect the other oscillator it is coupled to. Couplings between oscillators within the group of relay oscillators 810 are not expressly shown in FIG. 8 to emphasize that the coupling may take different configurations (e.g. temporal or spatial configurations as detailed below). Nevertheless, on-chip classical controller 814 may cause a first set of one or more pulses to be emitted through controller connection 826, wherein the first set of pulses couples one or more relay oscillators of the group of relay oscillators 810 to the output oscillator 806 (e.g., turn on coupling 820). The on-chip classical controller 814 is further configured to cause a second set of one or more pulses to be emitted through 830, wherein the second set of pulses couples one or more relay oscillators of the group of relay oscillators 810 to the additional relay oscillator 812 (e.g., turn on coupling 822). The on-chip classical controller 814 is further configured to cause a third set of one or more pulses (for example, set of pulses 834) to be emitted, wherein the third set of pulses 834 couples the additional relay oscillator 812 to the input oscillator 808 (e.g., turn on coupling 824).

In some embodiments, an additional relay oscillator 812 takes on an expectation value of an output oscillator 806 based at least in part on a coupling or couplings between a group of relay oscillators 810, wherein respective relay oscillators of group 810 comprise respective sample values of the output oscillator 806. The additional relay oscillator 812 may take on the expectation value of output oscillator 806 based at least on respective sample values taken on by respective relay oscillators. Furthermore, additional relay oscillator 812 may transfer the taken on expectation value to input oscillator 808 via controller 814 causing coupling 826 to turn on.

In some embodiments, bias oscillators such as bias oscillator 818 may be used, for example, to stabilize relay oscillators of the relay gadget. In some embodiments, relay gadget 804 may be implemented without bias oscillators such as 818.

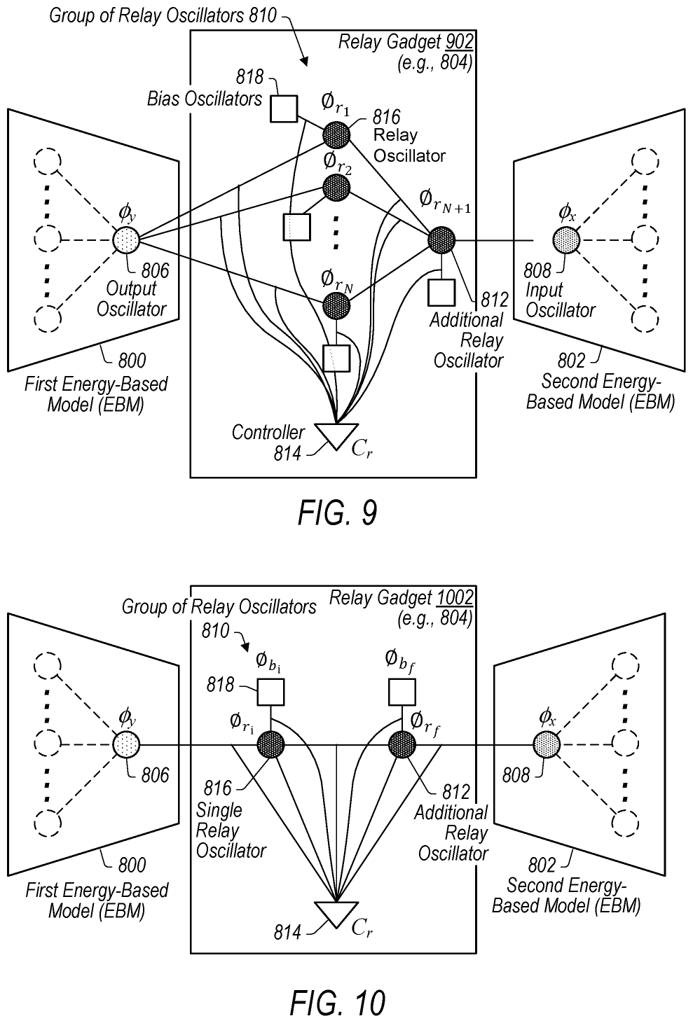

FIG. 9 is a high-level diagram illustrating a spatial analogue relay gadget, wherein respective ones of relay oscillators of a group of relay oscillators are configured to store respective sample values of an output oscillator, according to some embodiments.

In some embodiments, relay gadget 902 may be a spatial analogue relay gadget. In some embodiments, controller 814 sends a first set of one or more pulses wherein the first set of pulses causes output oscillator 806 of first energy-based model (EBM) 800 to be coupled to at least one or more relay oscillators {ϕᵣ_{₁}, ϕᵣ_{₂}, . . . ϕᵣ_{_{N}}}, in the group of relay oscillators 810. Group of relay oscillators 810 comprises a plurality of relay oscillators, wherein respective relay oscillators {ϕᵣ_{₁}, ϕᵣ_{₂}, . . . ϕᵣ_{_{N}}}, are configured to store a sample of the output oscillator 806 based at least in part on respective couplings between the respective ones of the relay oscillators (e.g., 816) of the group of relay oscillators 810 and the output oscillator 806. The on-chip classical controller 814 is further configured to cause another set of one or more pulses to be emitted, wherein the other set of pulses turns off the respective couplings between the output oscillator 806 and the respective ones of the relay oscillator of the group of relay oscillators 810 at different times. This may allow different samples of the output oscillator 806 to be stored on the respective ones of the relay oscillators {ϕᵣ_{₁}, ϕᵣ_{₂}, . . . ϕᵣ_{_{N}}}.

On-chip classical controller 814 may be further configured to cause a second set of one or more pulses to be emitted, wherein the second set of pulses turns on the coupling between respective ones of the relay oscillators with sample values of the output oscillator 106 to an additional relay oscillator 812. The coupling is configured to transfer an approximation of the expectation value of output oscillator 806 based at least in part on the sample values stored on respective relay oscillators in the first group of relay oscillators 810. Once the additional relay oscillator 812 is tuned to the expectation value of output oscillator 806, controller 814 may cause a set of one or more pulses that may cause the additional relay oscillator to be coupled to input oscillator 808. In some embodiments, bias oscillators such as bias oscillator 818 may be used, for example, to stabilize relay oscillators of the relay gadget. In some embodiments, relay gadget 804 may be implemented without bias oscillators such as 818.

FIG. 10 is a high-level diagram illustrating a temporal analogue relay gadget, wherein a group of relay oscillators comprises a single relay oscillator, according to some embodiments.

In some embodiments, relay gadget 1002 may be a temporal analogue relay gadget. In some embodiments, the group of relay oscillators 810 comprises a single relay oscillator 816. The single relay oscillator 816 is configured to store a sample of the output oscillator 806 based at least in part on the coupling between the single relay oscillator 816 and the output oscillator 806. The coupling between output oscillator 806 and single relay oscillator 816 is caused by a first set of one or more pulses emitted from on-chip classical controller 814. The on-chip classical controller 814 is configured to cause a second set of one or more pulses to be emitted, wherein the second set of pulses causes the single relay oscillator 816 to be coupled to additional relay oscillator 812. The sequence of emitting the first set of pulses and then emitting the second set of pulses may be repeated numerous times. Each instance the sequence of the sequential sets of pulses is emitted, the position of additional relay oscillator 812 is incrementally adjusted. Each adjustment may converge the additional relay oscillator 812 to the expectation value of output oscillator 806.

In some embodiments, bias oscillators such as bias oscillator 818 may be used to stabilize relay oscillators of the relay gadget. In some embodiments, relay gadget 804 may be implemented without bias oscillators such as 818.

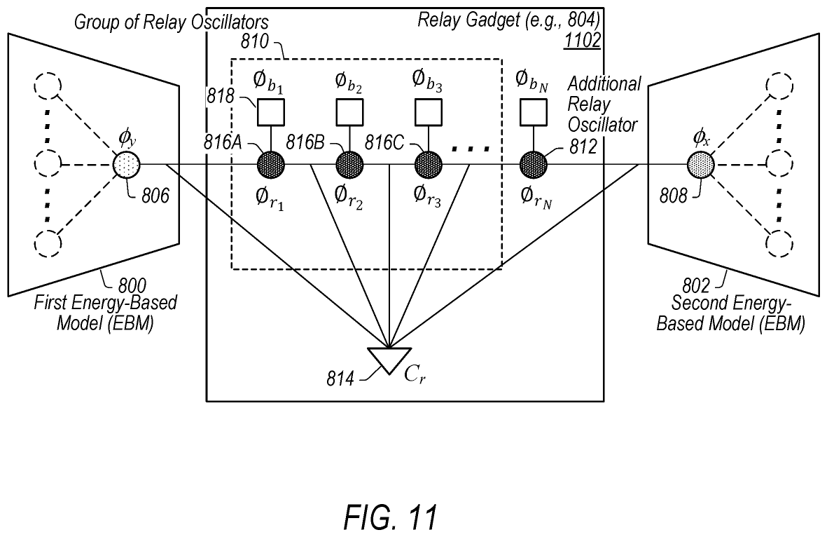

FIG. 11 is a high-level diagram illustrating a series analogue relay gadget, wherein a group of relay oscillators comprises a plurality of relay oscillators arranged in series, according to some embodiments.

In some embodiments, relay gadget 1102 may be a series analogue relay gadget. FIG. 11 shows a drawing of a series analogue relay gadget 804 such as shown in some embodiments. The group of relay oscillators 810 comprises a plurality of relay oscillators {ϕᵣ_{₁}, ϕᵣ_{₂}, . . . } (e.g. relay oscillator 816A, 816B, 816C) arranged one after another in series. Each relay oscillator has a product of mass and frequency squared. The first relay oscillator 816A, ϕᵣ_{₁}, has the smallest product of mass and frequency squared. The next relay oscillator 816B, ϕᵣ_{₂}, has a product of mass and frequency squared larger than the previous relay oscillator 816A, ϕᵣ_{₁}.This trend of increasing the product of mass and frequency squared continues for each subsequent relay oscillator in the group of relay oscillators 810. As last in the chain of relay oscillators, the additional relay oscillator 812 has the largest product of mass and frequency squared. The couplings between relay oscillators and the coupling between the output oscillator 806 and the first relay oscillator 816A, ϕᵣ_{₁}, may be turned on at the same time and allowed to evolve thermodynamically according to Langevin dynamics. Once coupling is initiated, each successive relay oscillator takes continuous samples of the previous oscillator it is coupled to. Furthermore, each successive relay oscillator may be a closer approximation of the expectation value of the output oscillator 806. In this manner, additional relay oscillator 812 approximates an expectation value of input oscillator 806. At this point, coupling between the additional relay oscillator 812 and input oscillator 808 may be turned on and the thermodynamic information may be transferred to input oscillator 808. The number of relay oscillators and the timing of coupling may be chosen beforehand and optimized for a desired precision or accuracy of the expectation value of the output relay oscillator.

In some embodiments, bias oscillators such as bias oscillator 818 may be used to stabilize relay oscillators of the relay gadget. In some embodiments, relay gadget 804 may be implemented without bias oscillators such as 818.

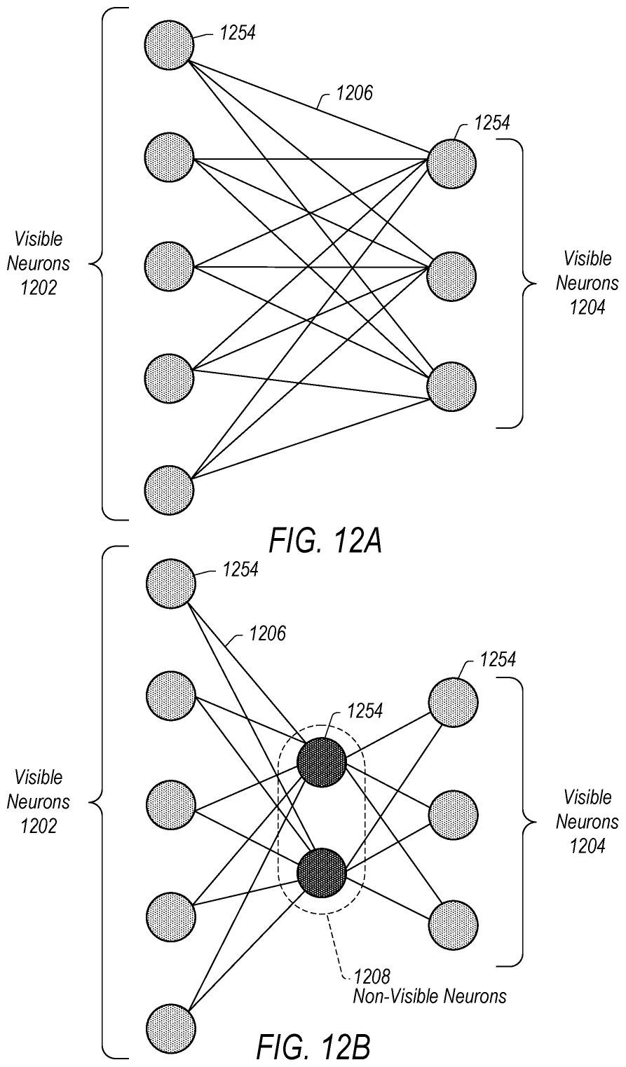

FIG. 12A illustrates example couplings between visible neurons of an energy-based model (EBM), according to some embodiments.

In some embodiments, input neurons and output neurons of an energy-based model, such as visible neurons 1202 and visible neurons 1204, may be directly linked via connected edges 1206. As shown in FIG. 12A, a given visible neuron 1202 of the five shown in the figure is connected, via edges 1206, to each of the respective three visible neurons 1204. A person having ordinary skill in the art should understand that FIG. 12A is meant to represent example embodiments of a graph architecture implemented using a thermodynamic chip that may be applied and that specific numbers of visible neurons 1202 and/or visible neurons 1204 shown in the figure are not meant to be restrictive. Additional configurations combining more/less visible neurons 1202 and/or visible neurons 1204 are also encompassed by the discussion herein. In addition, recall that neurons are logical representations of physical oscillators, such that, when describing neurons in FIG. 12A and 12B, it should be understood that neurons and edges are implemented using oscillators and couplings.

FIG. 12B illustrates example couplings between visible neurons and non-visible neurons (e.g., hidden neurons) of an energy-based model (EBM), according to some embodiments.

In some embodiments, FIG. 12B may resemble additional example embodiments of an energy-based model architecture implemented using a thermodynamic chip. As shown in the figure, additional non-visible neurons 1208 may be used, which are respectively coupled, via edges 1206, to both visible neurons 1202 and to visible neurons 1204. Note that while the non-visible neurons are “not visible” from the perspective of inputs and outputs, the non-visible neurons may each correspond to a given oscillator. In addition, it may be noted that, in some embodiments that make use of non-visible neurons, no direct connections, via edges 1206, may be implemented between visible neurons 1202 and visible neurons 1204, but rather connections are routed firstly via non-visible neurons 1208, as shown in FIG. 12B. Couplings between visible and non-visible neurons may be additionally referred to herein as “layers” of a given energy-based model architecture that is implemented using a thermodynamic chip, according to some embodiments.

FIG. 13 is a high-level diagram illustrating oscillators included in a substrate of the thermodynamic chip and mapping of the oscillators to logical neurons of the thermodynamic chip, according to some embodiments.

In some embodiments, a substrate 1302 may be included in a thermodynamic chip, such as any one of the thermodynamic chips described above. Oscillators 1304 of substrate 1302 may be mapped in a logical representation 1352 to neurons 1354, as well as weights and biases (shown in FIG. 14). In some embodiments, oscillators 1304 may include oscillators with potentials ranging from a single well potential to a dual-well potential and may be mapped to visible neurons, weights, and biases.

In some embodiments, Josephson junctions and/or superconducting quantum interference devices (SQUIDS) may be used to implement and/or excite/control the oscillators 1304. In some embodiments, the oscillators 1304 may be implemented using superconducting flux elements (e.g., qubits). In some embodiments, the superconducting flux elements may physically be instantiated using a superconducting circuit built out of coupled nodes comprising capacitive, inductive, and Josephson junction elements, connected in series or parallel, such as shown in FIG. 13 for oscillator 1304. However, in some embodiments, generally speaking various non-linear flux loops may be used to implement the oscillators 1304, such as those having single-well potential, double-well potential, or various other potentials, such as a potential somewhere between a single-well potential and a double-well potential.

FIG. 14 is an additional high-level diagram illustrating oscillators included in a substrate of the thermodynamic chip mapped to logical neurons, weights, and biases of a given neuro-thermodynamic computing system, according to some embodiments.

While synapses such as weights and biases are not shown in FIG. 13 for ease of illustration, respective ones of the visible neurons 1354 of FIG. 13 may each have an associated bias, and edges connecting the neurons 1354 may have associated weights. For example, FIG. 12 illustrates an arrangement of five visible neurons along with associated weights and biases. Each of the weights and biases may be mapped to oscillators in the thermodynamic chip, as well as the visible (and non-visible) neurons being mapped to oscillators in the thermodynamic chip. For example, FIG. 14 shows a portion of a thermodynamic chip, wherein weights and biases associated with a given neuron 1454 are shown. For example, bias 1456 may be a bias value for visible neuron 1454 and weights 1458 and 1460 may be weights for edges formed between visible neuron 1454 and other visible neurons of the thermodynamic chip. As shown in FIG. 14, each of the chip elements (visible neuron 1454, bias 1456, weight 1458, and weight 1460) may be mapped to separate ones of oscillators 1404. This may allow the visible neurons (and/or hidden neurons), weights, and biases to have independent degrees of freedom within a given thermodynamic chip that can separately evolve.

FIG. 15 is a high-level flowchart illustrating a process of emulating deep neural diffusion using a deep energy-based model implemented on one or more thermodynamic chips to generate sample values, according to some embodiments.

In some embodiments, methods, systems, and apparatuses such as described herein may be used to emulate diffusion and generate sample input values of a deep neural network. An example process of an embodiment may be disclosed as follows. At block 1502, a deep EBM implemented on one or more thermodynamic chips may be enabled to thermodynamically evolve. In some embodiments, the deep EBM may comprise one or more EBMs and one or more oscillators that implement one or more energy potentials, wherein the one or more energy potentials govern the thermodynamic evolution.

In some embodiments, block 1502 may lead to block 1504 describing that a first set of relay oscillators may be coupled to respective oscillators of respective EBMs. For example, relay oscillators of a relay gadget may be coupled to one or more input oscillators or one or more output oscillators of respective EBMs. The coupling along with more thermodynamic evolution may enable gradient terms of respective EBMs to be determined and stored onto one or more oscillators of the first set of relay oscillators such as described at block 1506. For example, respective gradients of the respective EBMs with respect to one or more input values for the respective EBMs, wherein the one or more energy potentials are not perturbed (unperturbed gradients), are determined. Such gradients may refer to the gradients described in equation 2 and the surrounding description.

At block 1508, a second set of relay oscillators is introduced, wherein the second set of relay oscillators may be coupled to oscillators of respective EBMs. The coupling may be similar to how the first set of relay oscillators are coupled with oscillators of respective EBMs such as described immediately above; however, a key distinction is that one or more energy potentials of the EBMs may be perturbed while coupled to the one or more relay oscillators of the second set of relay oscillators. Consequently, at block 1510, the coupling may enable gradients of the EBMs with respect to one or more input values for the EBMs to be determined for perturbed energy potentials (perturbed gradients). Such perturbed gradients may refer to the gradients described in equation 9 and the surrounding description.

At block 1512, a third set of relay oscillators are introduced, wherein the third set of relay oscillators may be coupled to the first and second sets of relay oscillators. For such a coupling, the first and second sets of relay oscillators are held static at the gradient values obtained from previous coupling. The coupling of the third set of relay oscillators to the other two sets may be designed such that thermodynamic evolution of the third set of relay oscillators causes the third set of relay oscillators to compute a difference between the perturbed and unperturbed gradients. For example, see equation 12 and the surrounding description.

Alternative to block 1504, block 1502 may lead to block 1514. At block 1514, multiple position or momentum measurements of input or output oscillators of a given EBM may be measured. Such measurements may be sent to a classical computing device wherein, at block 1516, gradient terms of the given EBM with respect to one or more input values for the given EBM may be computed. Measurements may be taken in a forwards pass wherein one or more potentials of the EBMs are not perturbed and measurements may be taken in a backwards pass the wherein one or more potentials of the EBMs are perturbed. In such an embodiment, the measurements may be used to determine the unperturbed and perturbed gradients.

At block 1518, a classical computing device may determine a gradient of the deep EBM, with respect to a thermodynamic input of the deep EBM, based on the thermodynamic evolution of the deep EBM. In some embodiments, wherein blocks 1506-1512 are implemented, the third set of relay oscillators may be further coupled to output oscillators of respective EBMs to create the perturbed potential in equation 11. As described in FIG. 1, relay oscillators of the third group of relay oscillators may in turn be coupled to an EBM. For example, relay oscillators of the third set of relay oscillators that correspond to a last block may be coupled with one or more output oscillators of the last block and then thermodynamically evolve. Then, other relay oscillators of the third set of relay oscillators that correspond to a second to last block may be coupled with one or more output oscillators of the second to last block and then thermodynamically evolve. In this manner, relay oscillators of the third set of relay oscillators may be coupled with output oscillators of a previous block and thermodynamically evolve until the first block corresponding to a first EBM of the deep EBM is reached. In such an embodiment, relay oscillators of the third set of relay oscillators corresponding to the first EBM may reach the desired gradient of the deep EBM such as described in equation 3 and the surrounding description (see FIGS. 1 and 2). In embodiments, wherein blocks 1514 and 1516 are implemented, a classical computing device may calculate the deep EBM gradient based on the multiple measurements obtained.

At block 1520, a classical computing device may generate sample input values for the deep EBM based on the gradients of the deep EBM. In such an embodiment, deep neural diffusion may be emulated using one or more thermodynamic chips.

### Illustrative Computer System

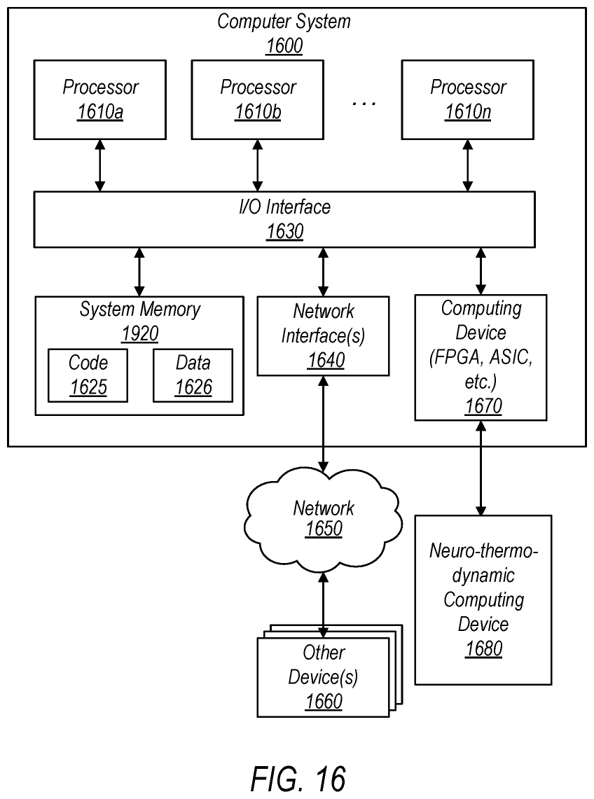

FIG. 16 is a block diagram illustrating an example computer system that may be used in at least some embodiments. In some embodiments, the computing system shown in FIG. 16 may be used, at least in part, to implement any of the protocols, techniques, etc. described above in FIGS. 1-15. For example, program instructions that implement protocols, techniques, etc. described herein may be stored in a non-transitory computer readable medium and/or may be executed by one or more processors, such as the processors of computer system 1600.

In the illustrated embodiment, computer system 1600 includes one or more processors 1610 coupled to a system memory 1620 (which may comprise both non-volatile and volatile memory modules) via an input/output (I/O) interface 1630. Computer system 1600 further includes a network interface 1640 coupled to I/O interface 1630. Classical computing functions may be performed on a classical computer system, such as computing computer system 1600.

Additionally, computer system 1600 includes computing device 1670 coupled to thermodynamic chip 1680. In some embodiments, computing device 1670 may be a field programmable gate array (FPGA), application specific integrated circuit (ASIC) or other suitable processing unit. In some embodiments, computing device 1670 may be a similar computing device as described in FIGS. 1-15, such as classical computing device 118. In some embodiments, thermodynamic chip 1680 may be a similar thermodynamic chip as described in FIGS. 1-15, such as thermodynamic chip(s) 100.

In various embodiments, computer system 1600 may be a uniprocessor system including one processor 1610, or a multiprocessor system including several processors 1610 (e.g., two, four, eight, or another suitable number). Processors 1610 may be any suitable processors capable of executing instructions. For example, in various embodiments, processors 1610 may be general-purpose or embedded processors implementing any of a variety of instruction set architectures (ISAs), such as the x86, PowerPC, SPARC, or MIPS ISAs, or any other suitable ISA. In multiprocessor systems, each of processors 1610 may commonly, but not necessarily, implement the same ISA. In some implementations, graphics processing units (GPUs) may be used instead of, or in addition to, conventional processors.

System memory 1620 may be configured to store instructions and data accessible by processor(s) 1610. In at least some embodiments, the system memory 1620 may comprise both volatile and non-volatile portions; in other embodiments, only volatile memory may be used. In various embodiments, the volatile portion of system memory 1620 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random-access memory (ReRAM), three-dimensional NAND technologies, Ferroelectric RAM, magneto resistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 1620 as code 1625 and data 1626.

In some embodiments, I/O interface 1630 may be configured to coordinate I/O traffic between processor 1610, system memory 1620, computing device 1670, and any peripheral devices in the computer system, including network interface 1640 or other peripheral interfaces such as various types of persistent and/or volatile storage devices. In some embodiments, I/O interface 1630 may perform any necessary protocol, timing or other data transformations to convert data signals from one component (e.g., system memory 1620) into a format suitable for use by another component (e.g., processor 1610). In some embodiments, I/O interface 1630 may include support for devices attached through various types of peripheral buses, such as a variant of the Peripheral Component Interconnect (PCI) bus standard or the Universal Serial Bus (USB) standard, for example. In some embodiments, the function of I/O interface 1630 may be split into two or more separate components, such as a north bridge and a south bridge, for example. Also, in some embodiments some or all of the functionality of I/O interface 1630, such as an interface to system memory 1620, may be incorporated directly into processor 1610.

Network interface 1640 may be configured to allow data to be exchanged between computing device 1600 and other devices 1660 attached to a network or networks 1650, such as other computer systems or devices. In various embodiments, network interface 1640 may support communication via any suitable wired or wireless general data networks, such as types of Ethernet network, for example. Additionally, network interface 1640 may support communication via telecommunications/telephony networks such as analog voice networks or digital fiber communications networks, via storage area networks such as Fibre Channel SANs, or via any other suitable type of network and/or protocol.

In some embodiments, system memory 1620 may represent one embodiment of a computer-accessible medium configured to store at least a subset of program instructions and data used for implementing the methods and apparatus discussed in the context of FIG. 1 through FIG. 15. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computer system 1600 via I/O interface 1630. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computer system 1600 as system memory 1620 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 1640. Portions or all of multiple computing devices such as that illustrated in FIG. 16 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computer system”, as used herein, refers to at least all these types of devices, and is not limited to these types of devices.

### Conclusion

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g., SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures above and described herein represent exemplary embodiments of methods. The methods may be implemented in software, hardware, or a combination thereof. The order of method may be changed, and various elements may be added, reordered, combined, omitted, modified, etc.

It will also be understood that, although the terms first, second, etc., may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A system comprising:
one or more thermodynamic chips, wherein oscillators of the one or more thermodynamic chips are configured to implement:
a deep energy-based model (deep EBM) configured to thermodynamically evolve, wherein the deep EBM comprises:
one or more energy-based models (EBMs) implemented using the oscillators, wherein:
respective oscillators of respective ones of the EBMs are mapped as neuron oscillators representing neuron values; and
other respective oscillators of the respective ones of the EBMs are mapped as synapse oscillators representing synapse values,
wherein the synapse oscillators when coupled with the neuron oscillators establish an energy potential that is configured to be perturbed;
one or more input oscillators configured to provide input thermodynamic information to the deep EBM;
an output oscillator configured to provide output thermodynamic information from the deep EBM, wherein the output thermodynamic information is encoded in an expectation value of the output oscillator,
wherein the thermodynamic evolution of the deep EBM processes the input thermodynamic information supplied by the one or more input oscillators; and
one or more classical computing devices configured to:
receive, subsequent to thermodynamic evolution of the deep EBM, measurement values of respective oscillators of respective ones of the one or more EBMs or measurement values of a set of relay oscillators configured to be measured;
determine a gradient for an evolved state of the deep EBM with respect to the input thermodynamic information provided to the deep EBM based on the received measurement values; and
generate sample input values for the deep EBM based on the gradient for the evolved state of the deep EBM.

2. The system of claim 1, wherein the one or more classical computing devices are configured to:
obtain gradients of the one or more EBMs, wherein the gradients of a given EBM of the one or more EBMs comprises:
a gradient of the given EBM with respect to one or more input values for the given EBM, wherein an energy potential of the given EBM is not perturbed (unperturbed gradient);
a gradient of the given EBM with respect to one or more input values for the given EBM, wherein the energy potential of the given EBM is perturbed (perturbed gradient);
a difference between the unperturbed gradient and perturbed gradient of the given EBM (difference of gradients), and
wherein the gradient of the deep EBM is based, at least in part, on the determined gradients of the one or more EBMs.

3. The system of claim 2, wherein the one or more thermodynamic chips further comprise:
a first set of relay oscillators configured to couple to respective oscillators of the one or more EBMs and thermodynamically evolve during a forward pass to compute the unperturbed gradient; and
a second set of relay oscillators configured to couple to respective oscillators of the one or more EBMs and thermodynamically evolve during a backward pass to compute the perturbed gradient;
the set of relay oscillators configured to be measured (third set of relay oscillators), that when coupled to the first and second sets of relay oscillators treated as static, cause the third set of relay oscillators to thermodynamically evolve to compute the difference of gradients,
wherein the one or more classical computing devices are further configured to measure the third set of oscillators to obtain the difference of gradients stored on the third set of relay oscillators.

4. The system of claim 2, wherein, for the given EBM of the one or more EBMs, the one or more classical computing devices are further configured to:
obtain measurements of respective oscillators of the given EBM that have thermodynamically evolved during a forward pass, wherein during the forward pass the energy potential of the given EBM is not perturbed;
calculate the unperturbed gradient of the given EBM based on the measurements obtained during the forward pass;
obtain measurements of respective oscillators of the given EBM that have thermodynamically evolved during a backward pass, wherein during the backward pass the energy potential of the given EBM is perturbed;
calculate the unperturbed gradient of the given EBM based on the measurements obtained during the forward pass;
calculate the difference between the unperturbed gradients and the perturbed gradients for the given EBM.

5. The system of claim 1, wherein the deep EBM further comprises:
one or more relay gadgets, wherein:
the one or more relay gadgets comprise relay oscillators configured to:
couple to an output oscillator of a given EBM of the deep EBM;
couple to an input oscillator of another given EBM of the deep EBM; and
relay thermodynamic information from the output oscillator of the given EMB of the deep EBM to the input of another EBM of the deep EBM.

6. The system of claim 1, wherein to generate sample input values of the deep EBM based on the gradient of the deep EBM, the one or more computing devices are further configured to:
implement a Langevin Markov chain Monte Carlo (MCMC) algorithm with the gradient of the deep EBM as an update parameter.

7. A system comprising:
one or more thermodynamic chips, wherein oscillators of the one or more thermodynamic chips are configured to implement:
a deep energy-based model (deep EBM) configured to thermodynamically evolve, wherein:
the deep EBM comprises one or more input oscillators and an output oscillator; and
the thermodynamic evolution of the deep EBM processes thermodynamic information; and
one or more classical computing devices configured to:
receive, subsequent to thermodynamic evolution of the deep EBM, measurement values of respective oscillators of the one or more thermodynamic chips;
determine a gradient of the deep EBM with respect to input thermodynamic information for the deep EBM based on the received measurement values; and
generate sample input values for the deep EBM based on the gradient of the deep EBM.

8. The system of claim 7, wherein the deep EBM further comprises:
one or more EBMs comprising oscillators, wherein:
the gradient of the deep EBM is based on gradients of the one or more EBMs; and
the gradients of the one or more EBMs comprise gradients of unperturbed EBMs and gradients of perturbed EBMs.

9. The system of claim 8, wherein the one or more thermodynamic chips further comprise:
one or more sets of relay oscillators, wherein the one or more sets of relay oscillators are configured to:
couple to respective oscillators of the EBMs; and
thermodynamically compute the gradients of unperturbed EBMs and gradients of perturbed EBMs.

10. The system of claim 8, wherein the one or more classical computing devices are further configured to:
measure respective oscillators of the EBMs corresponding to the unperturbed gradient or the perturbed gradient for respective EBMs; and
calculate the difference between the unperturbed gradients and the perturbed gradients for respective EBMs.

11. The system of claim 7, further comprising:
one or more relay gadgets, wherein the one or more relay gadgets comprise relay oscillators configured to relay thermodynamic information, in expectation value, from one EMB of the deep EBM to another EBM of the deep EBM.

12. The system of claim 7, wherein:
the thermodynamic evolution of the deep EBM enables an output oscillator of the deep EBM, in expectation value, to output a result of an engineered function.

13. The system of claim 7, wherein to sample input values of the deep EBM based on the gradient of the deep EBM, the one or more computing devices are further configured to:
implement a Langevin Markov chain Monte Carlo (MCMC) sampling algorithm with the gradient of the deep EBM as an update parameter.

14. A method comprising:
thermodynamically evolving a deep energy-based model (deep EBM), comprising one or more energy-based models (EBMs) and one or more oscillators, according to one or more energy potentials;
determining a gradient of the deep EBM with respect to a thermodynamic input of the deep EBM based on the thermodynamic evolution of the deep EBM; and
generating sample input values for the deep EBM based on the gradient of the deep EBM.

15. The method of claim 14, further comprising:
generating sample input values of the deep EBM based on the gradient of the deep EBM and a Langevin Markov chain Monte Carlo (MCMC) update algorithm, wherein the underlying distribution of the sample input values correspond to the one or more energy potentials of the deep EBM.

16. The method of claim 14, wherein to determine the gradient of the deep EBM, the method further comprises:
coupling a first set of relay oscillators to respective oscillators of respective EBMs of the one or more EBMs and thermodynamically evolving;
determining, by the first set of relay oscillators, respective gradients of the respective EBMs with respect to one or more input values for the respective EBMs, wherein the one or more energy potentials are not perturbed (unperturbed gradient);
coupling a second set of relay oscillators to respective oscillators of the respective EBMs and thermodynamically evolving;
determining, by the second set of relay oscillators, respective gradients of the respective EBMs with respect to one or more input values for the respective EBMs, wherein the one or more energy potentials are perturbed (perturbed gradient).

17. The method of claim 16, wherein to determine the gradient of the deep EBM, the method further comprises:
coupling a third set of relay oscillators to the first and second sets of relay oscillators treated as static, and thermodynamically evolving, wherein the thermodynamic evolution of the third set of relay oscillators cause the third set of relay oscillators to compute a difference between the perturbed and unperturbed gradients.

18. The method of claim 14, wherein to determine the gradient of the deep EBM, the method further comprises:
measuring multiple position or momentum measurements of respective input oscillators of a given EBM of the deep EBM; and
computing, by a classical computing device, the gradient of the given EBM of the deep EBM with respect to one or more input values for the given EBM.

19. The method of claim 14, wherein to thermodynamically evolve the deep EBM, the method further comprises:
coupling one or more respective relay oscillators of a relay gadget to an output oscillator of a given EBM of the deep EBM;
coupling one or more respective relay oscillators of a relay gadget to an input oscillator of another given EBM of the deep EBM; and
relaying thermodynamic information from the output oscillator of the given EMB of the deep EBM to the input of the other given EBM of the deep EBM.

20. The method of claim 14, wherein:
the thermodynamic evolution of the deep EBM enables an output oscillator of the deep EBM, in expectation value, to output a result of an engineered function.
